(19) United States
(12) Patent Application Publication
(10) Pub. No.: US 2024/0321469 A1
(43) Pub. Date: Sep. 26, 2024

(54) ALLOY FOR USE IN PLASMA CONFINEMENT SYSTEM

(71) Applicant: ZAP ENERGY, INC., Seattle, WA (US)

(72) Inventor: Clemente Jose Parga, Seattle, WA (US)

(21) Appl. No.: 18/613,013

(22) Filed: Mar. 21, 2024

Related U.S. Application Data
(60) Provisional application No. 63/454,018, filed on Mar. 22, 2023.

(51) Int. Cl. G21B 1/05; C22C 11/06; C22C 13/00; G21B 1/11

(52) U.S. Cl. CPC G21B 1/05; C22C 11/06; C22C 13/00; G21B 1/11

(57) ABSTRACT

Methods and systems are provided for improving operational performance of (e.g., increasing energy output from) Z-pinch and other plasma confinement systems. In one example, a plasma confinement system may include a liquid composition including a plurality of metals and having a lower vapor pressure, at a temperature level at which the plasma confinement system operates, than another composition formed from at least two of the plurality of metals. For instance, the liquid composition may include a ternary eutectic alloy which expands an operational range of the plasma confinement system to vapor pressures and/or temperatures not achievable with binary Pb—Li alloys.

### CROSS-REFERENCE TO RELATED APPLICATION

The present application claims priority to U.S. Provisional Application No. 63/454,018, entitled “ALLOY FOR USE IN PLASMA CONFINEMENT SYSTEM” and filed on Mar. 22, 2023. The entire contents of the above-identified application are hereby incorporated by reference for all purposes.

### FIELD

Embodiments of the subject matter disclosed herein relate to methods and systems for utilizing a liquid metal coating in plasma confinement applications, and more particularly utilizing the liquid metal coating to increase operational performance in higher vacuum and higher temperature sheared-flow stabilized (SFS) Z-pinch thermonuclear fusion devices.

### BACKGROUND

In order to improve nuclear fusion technologies, performance in higher vacuum and higher temperature environments is sought after. In a plasma confinement system, for example, alloys may be present in electrode compositions, but many existing alloys cannot support desired functionality of the plasma confinement system in lower pressure and higher temperature environments.

### BRIEF DESCRIPTION OF THE DRAWINGS

The above and other embodiments, features, and aspects of the present invention are considered in more detail in relation to the following description of embodiments shown in the accompanying drawings, in which:

FIG. 1 illustrates a schematic cross-sectional diagram of a plasma confinement system, including a flowing metal electrode coating, in accordance with at least one embodiment;

FIG. 2 illustrates an overview of a binary eutectic diagram, in accordance with at least one embodiment;

FIG. 3 illustrates exemplary trajectories of temperature dependent vapor pressure for Li, Pb, Sn, Pb-17Li eutectic, and 28Pb-20Li—Sn eutectic, in accordance with at least one embodiment;

FIG. 4 illustrates a lead-lithium (Pb—Li) equilibrium phase diagram, in accordance with at least one embodiment;

FIG. 5 illustrates a lead-tin (Pb—Sn) equilibrium phase diagram, in accordance with at least one embodiment;

FIG. 6 illustrates a lithium-tin (Li—Sn) equilibrium phase diagram, in accordance with at least one embodiment;

FIGS. 7A and 7B respectively illustrate Pb—Li—Sn ternary diagram isothermal sections at 250° C. and 350° C., in accordance with at least one embodiment;

FIG. 8 illustrates a Pb—Li—Sn system liquidus projection displaying isothermal liquidus lines, in accordance with at least one embodiment;

FIG. 9 illustrates a schematic diagram of deuterium-tritium fusion and a tritium blanket with nucleus and neutron reactions, in accordance with at least one embodiment;

FIGS. 10A and 10B illustrate neutron energy dependent neutron cross-sections for Li, Pb, Be, and Sn, in accordance with at least one embodiment;

FIG. 11 illustrates an effect of Sn concentration on tritium breeding ratio for natural and enriched Li, in accordance with at least one embodiment;

FIG. 12 shows a block diagram of a method for operating a plasma confinement system including a flowing metal electrode coating, for example, by selecting a metal alloy composition of the flowing metal electrode coating to optimize operation of sheared-flow stabilized (SFS) Z-pinch thermonuclear fusion devices, in accordance with at least one embodiment; and

FIGS. 13A-13F show schematic cross-sectional diagrams of a process of initiating and driving a sheared ion velocity flow in the plasma confinement system of FIG. 1 for stabilization of a Z-pinch discharge, in accordance with at least one embodiment.

### DETAILED DESCRIPTION

Techniques described and suggested herein include a plasma confinement system (e.g., a Z-pinch plasma confinement system, such as a SFS Z-pinch plasma confinement system), including a solid conductive shell and a liquid composition coating at least a portion of the solid conductive shell, the liquid composition including a plurality of metals and having a lower vapor pressure, at a temperature level at which the plasma confinement system operates, than another composition formed from at least two of the plurality of metals. In certain embodiments, the plurality of metals may mutually act as a heat transfer medium, a tritium-breeding blanket, and a radiation shield.

In at least one embodiment, a method (e.g., for operating a Z-pinch plasma confinement system) may include inducing flow of a eutectic alloy, the eutectic alloy including a first metal, a second metal, and a third metal, the first metal reducing a vapor pressure of an alloy formed from the second and third metals.

A Z-pinch plasma confinement system (e.g., configured in a thermonuclear fusion device, such as a SFS Z-pinch deuterium-tritium thermonuclear fusion device) in accordance with various embodiments includes an electrode including an electrode material which freely flows at an operating temperature range of the Z-pinch plasma confinement system and has a lower vapor pressure than a binary Pb—Li alloy within the operating temperature range.

These, as well as other aspects, advantages, and alternatives will become apparent to those of ordinary skill in the art by reading the following detailed description, with reference where appropriate to the accompanying drawings. Further, it should be understood that descriptions and figures provided herein are intended to illustrate the invention by way of example only and, as such, that numerous variations are possible.

For example, the following description relates to various embodiments of systems and methods for confining a plasma within a fusion device to sufficient temperature and sufficient density for sufficient duration to induce thermonuclear fusion. In some embodiments, output from the thermonuclear fusion may be harnessed for energy generation/storage. However, other use cases are envisioned for the disclosed embodiments or variations thereof, such as propulsion (e.g., for space vehicles, aircraft, watercraft and submersibles, etc.), research, etc. In extreme environments (e.g., reduced gravity environments aboard space vehicles), certain modifications may be made, e.g., to maintain performance.

In an example embodiment, a ternary eutectic alloy is incorporated into a plasma confinement system, e.g., to act as a coolant or a heat transfer medium, a tritium-breeding blanket, and/or a radiation shield. An alloy may include a metallic substance that is composed of two or more elements. Alloying elements (solutes) may be added to a base metal (solvent) to improve its properties, such as mechanical, corrosion-resistance, and thermophysical properties, among other properties. A solvent may represent the element or compound that may be present in the greatest amount; on occasion, solvent atoms are also called host atoms. A solute may be used to denote an element or compound present in a minor concentration. The addition of impurity atoms to a metal may result in the formation of a solid solution and/or a new second phase, depending on the kinds of impurities, their concentrations, and the temperature of the resulting alloy. If two liquids soluble in each other (such as water and alcohol) are combined, a liquid solution may be produced as the molecules intermix, and its composition may be homogeneous throughout.

In an exemplary embodiment, various components of the ternary eutectic alloy mutually act together or interact with one another to adjust (e.g., decrease or increase magnitude(s) of) one or more physical properties of the individual components in isolation.

Impurity point defects may be found in solid solutions, of which there are at least two types: substitutional and interstitial. For the substitutional type, solute or impurity atoms may replace or substitute for the host atoms. Several features of the solute and solvent atoms may determine the degree to which the former dissolves in the latter. The Hume-Rothery rule of mixtures may determine the compatibility of two or more elements, based on the following:
Atomic size factor
   Appreciable quantities of a solute may be accommodated in substitutional solid solutions when (e.g., only when) the difference in atomic radii between the two atom types is less than ±15%. Otherwise, the solute atoms may create substantial lattice distortions and a new phase may form.
Crystal structure
   For appreciable solid solubility, the crystal structures for metals of both atom types may be the same.
Electronegativity
   The more electropositive one element is and the more electronegative another element is, the greater the likelihood that they may form an intermetallic compound instead of a substitutional solid solution.
Electron valences
   Other factors being equal, a metal may have more of a tendency to dissolve another metal of higher valency than one of a lower valency.

For interstitial solid solutions, impurity atoms may fill the voids or interstices among the host atoms. For metallic materials that have relatively high atomic packing factors, these interstitial positions may be relatively small. Consequently, the atomic diameter of an interstitial impurity may be substantially (when the term “substantially” is used herein, it is meant that the recited characteristic, parameter, or value need not be achieved exactly, but that deviations or variations, including, for example, tolerances, measurement error, measurement accuracy limitations, and other factors known to those of skill in the art, may occur in amounts that do not preclude the effect the characteristic was intended to provide) smaller than that of the host atoms (e.g., <59% of a radius of the solvent atoms). The electronegativity and valence of interstitial atoms and solute may also be similar. The greater the difference in these parameters, the lower may be the solubility. In certain examples, the maximum allowable concentration of interstitial impurity atoms may be low (e.g., less than 10%). Even relatively small impurity atoms may be larger than the interstitial sites, and as a consequence they may introduce some lattice strains on the adjacent host atoms.

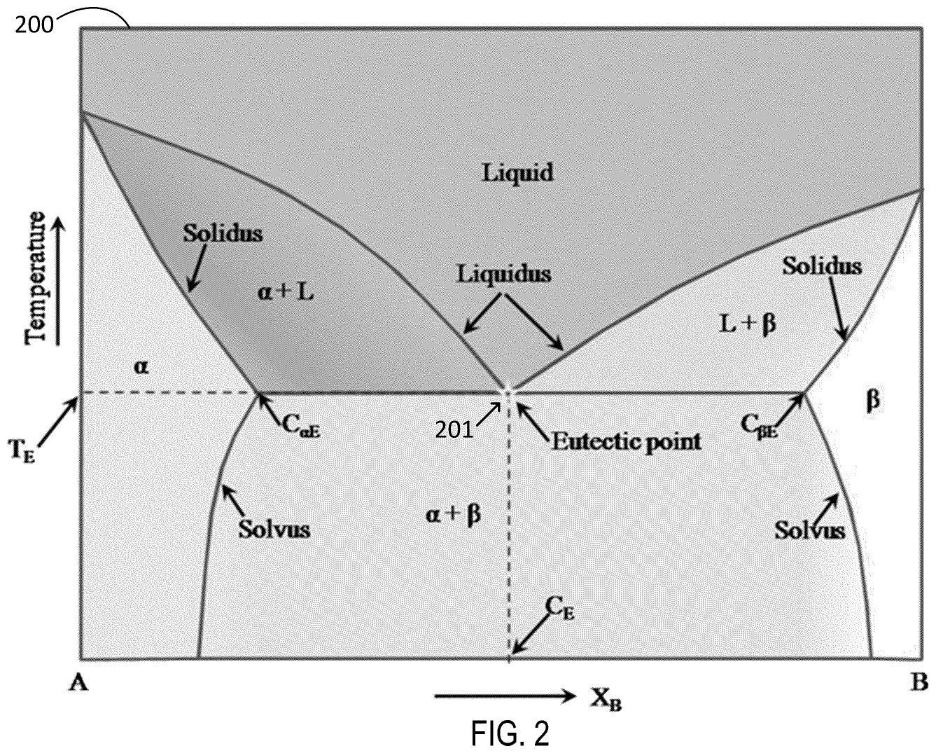

An exemplary binary eutectic phase diagram 200 at standard pressure (e.g., 1 atm) is shown in FIG. 2 with the pertinent regions of equilibrium phase stability depicted as a function of temperature and chemical concentration, along with a eutectic point 201 and reference lines of transformation.

The eutectic point 201 may represent an equilibrium invariant point where the lowest Gibbs free energy is attained for the coexistence of three phases: one liquid phase L with the eutectic composition C_{E} and two distinct solid phases α and β with compositions C_{αE} and CBE_{βE}, respectively. A eutectic system may include a mixture of chemical compounds or elements that have a single chemical composition at a lower temperature than any other composition made up of the same ingredients. In an equilibrium phase diagram, the eutectic may be indicated by an invariant point fixed by a specific composition C_{E} and temperature T_{E} at which the eutectic mixture transforms upon heating or cooling. Therefore, the eutectic reaction may be expressed as the following: L(C_{E})⇄α(C_{αE})+β(C_{βE}), where a liquid L may transform congruently into two dissimilar solid phases α and β upon steady cooling (e.g., cooling at a single, predetermined rate), and where the inverse reaction may take place upon steady heating. Once well mixed, a eutectic substance may remain homogeneous, and may melt and solidify at a given temperature, as a pure substance does; at least this characteristic makes it usable as a liquid metal blanket.

The temperature and the pressure may be considered dependent properties for pure substances during phase-change processes. At a given pressure, the temperature at which a pure substance changes phase may be called the saturation temperature, Tₛₐₜ. Likewise at a given temperature, the pressure at which a pure substance changes phase may be called the saturation pressure, Pₛₐₜ. At an absolute pressure (when the term “absolute pressure” is used herein, it may refer to an amount relative to an idealized pressure of having no matter inside a space, or a perfect vacuum) of 1 standard atmosphere (1 atm, or 101.325 kPa), the saturation temperature of lithium, lead, and tin may be 1342° C., 1750° C., and 2602° C., respectively.

The dependence of the boiling temperature, T_{B}, on pressure may be presented inversely as a function of the saturated vapor pressure on the boiling temperature pₛₐₜ=pₛ(T_{B}). The saturated vapor pressure of liquid metals may be related to the latent heat of evaporation and to the cohesive energy. For the equilibrium between liquid and vapor phases of a substance, the Clausius-Clapeyron equation may be written as:

$$( \frac{d {p}_{s}}{d {T}_{B}} ) = \frac{{H}_{v} - {H}_{1}}{{T}_{B} ( {V}_{v} - {V}_{1} )} \qquad ( 1 )$$

where T_{B} is the boiling temperature at a given pressure, Hₗ, Hᵥ are molar (or specific) enthalpies, and Vₗ, Vᵥ are molar (or specific) volumes of the liquid phase and the gas phase, respectively. Assuming that the vapor behaves as an ideal gas and neglecting the volume of liquid in comparison with that of the gas, the saturated vapor pressure (pₛ) may be obtained from equation (1) as:

$${p}_{s} ( {T}_{B} ) = A \cdot exp ( - \frac{Δ {H}_{B}}{R \cdot {T}_{B}} ) \qquad ( 2 )$$

where A is a constant of integration and ΔH_{B} is the heat (e.g., enthalpy) of evaporation (e.g., boiling).

Equation (2) may provide approximate values for equilibrium vapor pressures over a wide range of temperatures, e.g., due to the relatively small variation of ΔH_{B} with temperature at low pressures. In certain examples, closer fits of the experimental results may be obtained by adding supplementary temperature dependent terms; one possible form is:

$$log ( {p}_{s} ( {T}_{B} ) ) = A + \frac{B}{{T}_{B}} + C \cdot log ( {T}_{B} ) + D \cdot {T}_{B} \qquad ( 3 )$$

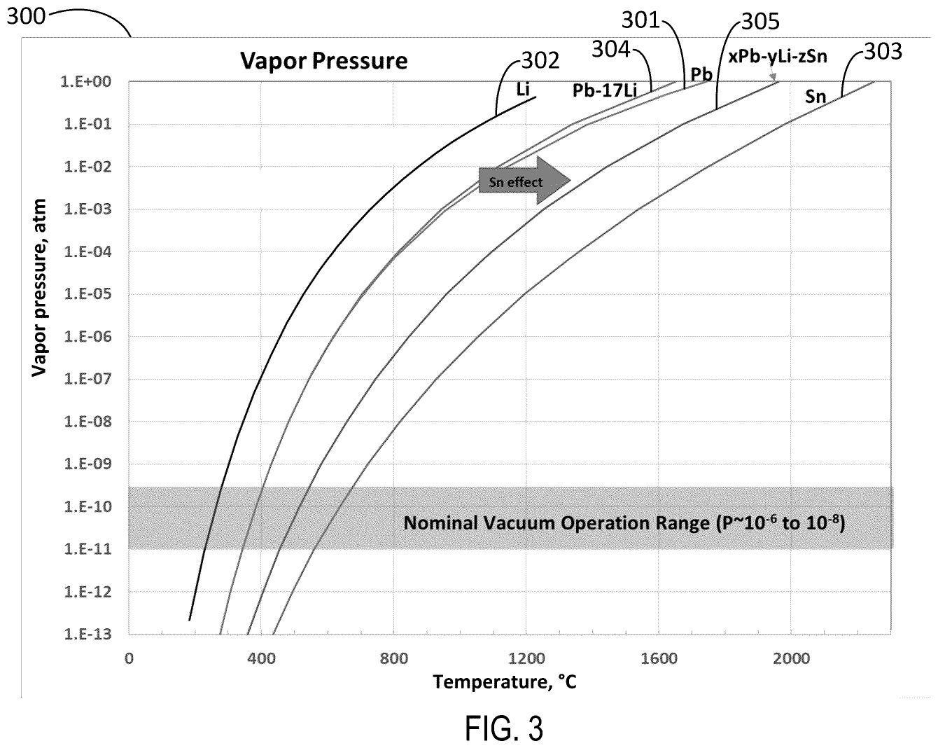

The vapor pressures of liquid lithium, lead, tin, and Pb-17Li eutectic (e.g., eutectic alloy) are respectively portrayed by curves 301, 302, 303, and 304 in a plot 300 illustrated in FIG. 3. When lithium and lead are mixed to form a Pb-17Li lead-based alloy (e.g., corresponding to a eutectic mix with composition of 83% Pb +17% Li in atomic percent), the vapor pressure may significantly shift towards that of lead, and may result in depression of the overall vapor pressure of Pb-17Li relative to that of pure lithium.

The vapor pressure of Sn may be several orders of magnitude lower than that of either Pb or Li, as observed in FIG. 3. In certain embodiments, Sn may be used as an additive in a Pb—Li mix (eutectic or solid solution alloy) to further accentuate the effect on the depression of the vapor pressure of any binary Pb—Li alloy. A binary Pb—Li alloy may be an alloy with Pb and Li, optionally including other components. This mélange may encompass a Pb—Li—Sn ternary (or three-element mixture) where the addition of a certain proportion of Sn to Pb—Li may effectively depress the vapor pressure (e.g., relative to a Pb-17Li alloy).

Indicated by curve 305 in FIG. 3 is a 28Pb-20Li—Sn eutectic (e.g., eutectic alloy), wherein the alloy remains freely flowing (e.g., allowing for operational performance of a plasma confinement system) when, for example, the vapor pressure is less than 10⁻⁹ atm and the operating temperature is about 600°° C. (e.g., at 600° C. or within a threshold range inclusive of deviations from a nominal value of 600° C. during operation of a plasma confinement system). The operating temperature range may include the temperatures in which operational performance of a plasma confinement system can be achieved, e.g., at a given vapor pressure range, by the alloy remaining freely flowing. For instance, the operating temperature range, e.g., at which the alloy remains freely flowing, may be between 500° C. and 700° C. when the vapor pressure range, e.g., induced by the alloy, is between 10⁻¹⁰ atm and 10⁻⁸ atm.

One advantage of the addition of Sn to the Pb—Li alloy may include operation as a liquid metal blanket at relatively higher temperature (hundreds of degrees Celsius; e.g., as high as 1200° C. or higher) and higher vacuum conditions (several orders of magnitude below atmospheric pressure; e.g., as low as 10-3 atm or lower) than possible with the use of pure-Li or Pb-17Li substances. For example, if half the concentration of lead were to be substituted by tin in the Pb-17Li alloy to form a liquid solution of (Pb,Sn)-17Li, the operational limit of the liquid metal blanket may increase by about 200° C. (e.g., from 600 to 800° C. at 10⁻⁶ atm) or 3 orders of magnitude lower pressure (e.g., 10⁻⁶ to 10⁻⁹ atm at 600° C.). Accordingly, the Pb—Li—Sn alloy may increase the overall thermal efficiency of a thermonuclear fusion energy system and the attainment of an engineering energy breakeven.

Evaluating the compatibility between Pb, Li, and Sn may be key to understanding their mutual solubility and probable existence of ternary eutectic alloys in this ternary system. Selected characteristics, crystalline structures, and thermophysical properties of these elements are presented in Table 1. By applying Hume-Rothery's alloying rules, it may be observed that Pb, Sn, and Li share some common characteristics:
Favorable atomic radius: an absolute difference in atomic radii of about 15% or less.
Some crystal lattice affinity: face centered cubic (FCC), diamond, and/or hexagonal close-packed (HCP); closed-packed lattices; various slip planes.
Electron valence match (Pb and Sn: +4, +2; Li: +1).
Electronegativity difference of 0.37 between Pb and Sn, or about (e.g., within ±5% of a nominal value) >96% metallic bonding.
Relatively low melting points, within a narrow range of one another (e.g., ΔTₘ<150° C.).

TABLE 1
Selected characteristics and properties of Pb, Li, and Sn.

| | | | | | | Atomic | Ionic | Atomic | | |
|---|---|---|---|---|---|---|---|---|---|---|
| | | A | Tₘ | T_{B}, | ρ | radius | radius | lattice | Pauling's | Electron |
| Element | Z | (amu) | (° C.) | (° C.) | (g/cc) | (nm) | (nm) | structure | electronegativity | valence |
| Li | 3 | 6.940 | 180.5 | 1342 | 0.534 | 0.152 | 0.068 | α, HCP < | 0.98 | 1 |
| | | | | | | | | −193° C. < | | |
| | | | | | | | | β, BCC | | |
| Pb | 82 | 207.21 | 327.5 | 1750 | 11.35 | 0.175 | 0.120 | FCC | 2.33 | 2, 4 |
| Sn | 50 | 118.70 | 231.9 | 2602 | 7.17 | 0.151 | 0.071 | α, diam. < | 1.96 | 4, 2 |
| | | | | | | | | 13° C. < β, | | |
| | | | | | | | | tetr. | | |

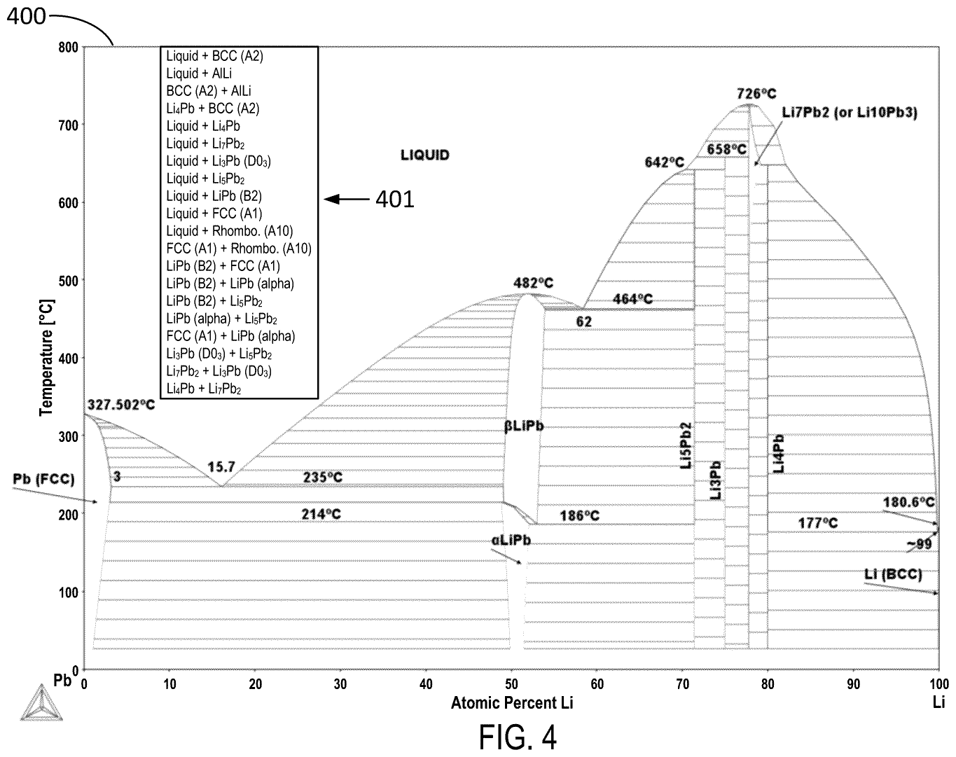

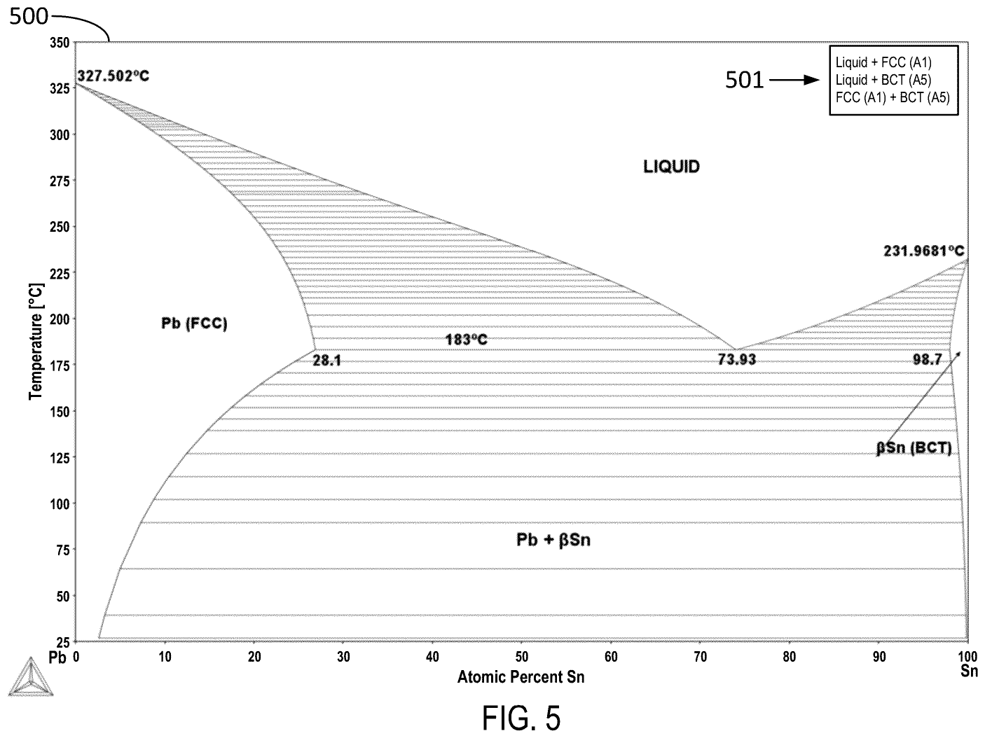

Alloy design is complex because the process relies on numerous parameters, each of which may interact with one another to generate a combinatorial explosion of possible alloys. For example, various properties of Pb, Li, and Sn may affect their mutual solubility. When such elements are alloyed, the formation of intermediate phases and eutectics (e.g., eutectic alloys) may result. Using Thermo-Calc, the CALculation of PHAse Diagrams (CALPHAD) method was applied to model thermodynamic equilibrium phase diagrams 400, 500, and 600 (as shown in FIGS. 4-6, respectively). In the diagrams 400, 500, and 600, various alloys or other species which may appear within temperature ranges indicated by corresponding ordinates of the diagrams 400, 500, and 600 and including atomic percentages indicated by corresponding abscissas of the diagrams 400, 500, and 600 are tabulated in boxes 401, 501, and 601, respectively.

The following features are indicated in the diagrams 400, 500, and 600. In the Pb—Li system, and as shown by the diagram 400, Pb may dissolve up to 3% Li at 235° C., multiple intermetallic phases may form when 50% Li or more is added to Pb, and two cutectics may exist at 15.7% Li (235° C.) and 62% Li (464° C.). In the Pb—Sn system, and as shown by the diagram 500, Pb and Sn may exhibit relatively higher miscibility, where Pb may dissolve up to 28.1% Sn (183° C.), no intermetallic phases may be formed, and a lower temperature eutectic may exist at Sn-26.07Pb (183° C.). In the Li—Sn system, and as shown by the diagram 600, there may be no, or nearly no, solubility between Li and Sn; nonetheless, a eutectic may exist at Li-45.1Sn (470° C.), and multiple compounds may be formed for mixes of more than 27% Li with Sn. If the analysis is expanded to the Pb—Li—Sn ternary system, lead may increase the mutual solubility of Li and Sn. The addition of Sn may potentially induce lower temperature Pb+Li+Sn eutectics. The ternary system may include formulations that better balance the individual attributes of each element (and the Pb-17Li cutectic), including formulations that may be more appropriate for high vacuum and higher temperature service conditions.

Certain characteristics of the Pb—Li—Sn system may be elucidated through Thermo-Calc modeling using the “SSOL7 SGTE Solutions Database,” which includes critical assessments for binary, ternary, and some higher order systems. However, the SSOL7 database does not include any specific experimental data on the ternary Pb—Li—Sn system alloys, nor any three-element compounds. Nonetheless, modeling may aid predictions based on thermodynamic principles and data from the Pb—Li, Pb—Sn, and Li-Sn binary systems, and from similar ternary systems.

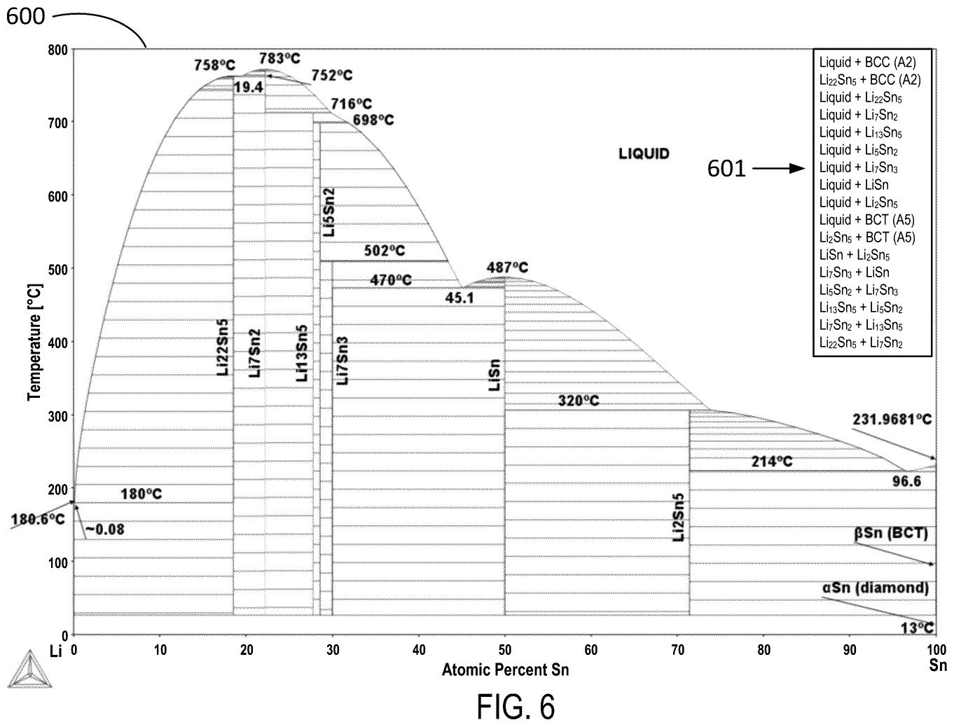

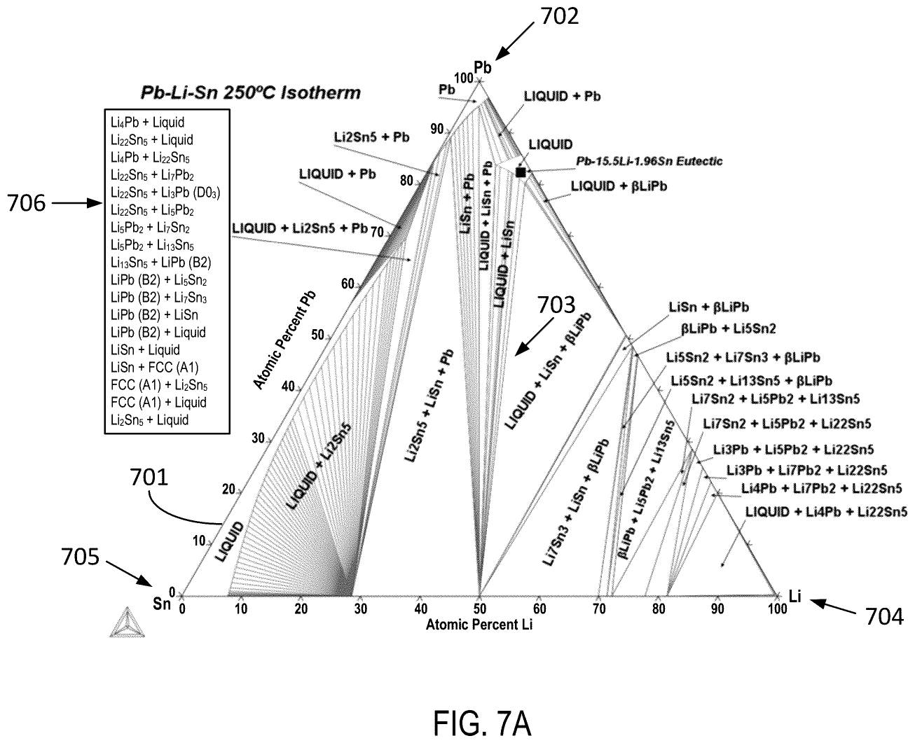

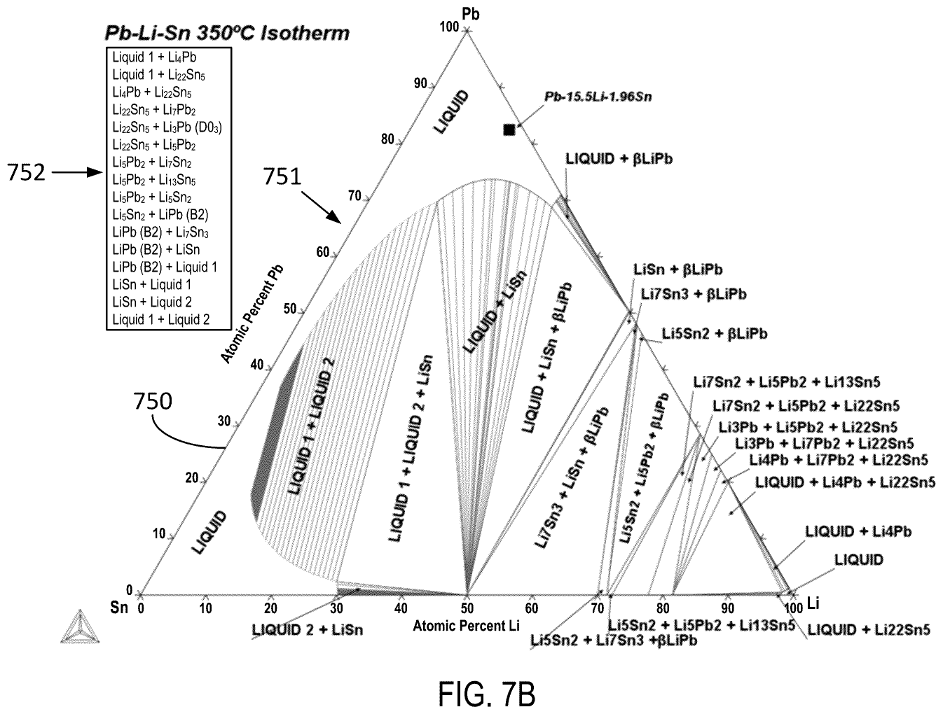

Expanding upon the binary diagrams discussed above, a pair of ternary isotherms 701 and 750 (fixed-temperature three-element triangular phase diagrams) corresponding to the phase stability in the Pb—Li—Sn system were respectively calculated at 250° C. and 350° C. (as shown in FIGS. 7A and 7B, respectively). In the isotherms 701 and 750, various alloys or other species which may include atomic percentages indicated by corresponding axes of the isotherms 701 and 750 are tabulated in boxes 706 and 752, respectively. The isotherms 701 and 750 may indicate demarcation of regions where distinct phase(s) are in thermodynamic equilibrium and coexist within a predetermined concentration range at constant temperature. For example, at 250° C. (FIG. 7A), the lead-rich corner 702 indicates a stable single phase Pb (FCC) region where small proportions of lithium (<4% Li) and tin (<15% Sn) can be dissolved in lead. Moving away from the Pb-rich corner towards the center 703 of the isotherm 701, the formation of LiSn, LiPb, and LizSns compounds may be observed. Moving towards the Li-rich corner 704, the coexistence of increasingly more complex intermetallics may be observed, matching phases observed in the binary Li—Sn and Li—Pb diagrams (see FIGS. 4 and 6). The regions where single liquid phases are present may contain ternary eutectic points. For example, the composition corresponding to Pb-15.5Li-1.96Sn is indicated (square bullet point) because it may be analogous to the binary Pb-15.7Li cutectic with some dilute concentration of Sn of about 2 atomic percent. Next, in the Sn-rich corner 705, a single solution of homogeneous liquid phase extending from 100% Sn to about 70% Pb may be observed, with varying proportions of Li (<8% Li).

Moving to the isotherm 750, there may be substantial growth of the single-phase liquid region 751, which may completely connect the Pb and Sn corners and may contain up to 30% lithium in certain regions. In some examples, a two-phase region where Liquid 1+Liquid 2 coexist but are immiscible in each other may be present, analogous to what may be observed when water and oil are mixed. Liquid 2 may be richer in Li+Sn and Liquid 1 may be richer in Pb+Sn. Accordingly, lithium may have some lower compatibility issues, but solubility may improve as lead is added promoting the formation of a single phase Liquid (Pb, Li,Sn) closer to the Pb-and Sn-rich corners.

No three element phases (for example, PbₓLi_{y}Sn_{z}) can be explicitly modeled with the SSOL7 thermodynamic database, but this does not mean that these phases do not exist—an experimental determination may be used to identify them. To evaluate the extent of missing experimental data, a liquidus projection plot may be calculated with SSOL7. A liquidus projection may be a two-dimensional projection of ternary univariant lines at constant pressure. Such ternary univariant lines, or cotectics, may include lines along which three phases coexist at constant pressure. Construction of phase diagrams, as well as some principles governing conditions for phase equilibria, may be dictated by the Gibbs phase rule. The Gibbs phase rule may provide a criterion for a number of phases which may coexist within a system at equilibrium, and may be expressed as follows:

$$P + F = C + N$$

where P is a number of phases present (e.g., P=3), F is a number of degrees of freedom (e.g., F=1), C is a number of components (e.g., C=3), and N is a number of non-compositional variables (e.g., N=1). Specifically, F is the number of degrees of freedom or a number of externally controlled variables (e.g., temperature, pressure, composition, and the like) which may be constrained to specify (e.g., completely specify) a state of a system. Alternatively expressed, F is a number of such variables which may be independently adjusted without altering a number of phases that coexist at equilibrium. C is the number of components, such as elements and/or stable compounds. In the case of phase diagrams, such components may include materials at two extremities of a horizontal compositional axis (e.g., Sn, Pb, and Li). N is the number of non-compositional variables, such as temperature and/or pressure.

In a liquidus projection, isothermal lines (e.g., plotted at fixed temperature) may be present where a liquid and a solid are in thermodynamic equilibrium. Liquidus lines may also trace the varying elemental composition of the liquid phase. Liquidus projections may be used to highlight two-dimensional liquidus surfaces in a three-element system. A two-dimensional section of a liquidus projection may consist of univariant lines of three-phase equilibria between liquid and other phases. Analogous liquidus lines are depicted in the binary eutectic phase diagram 200 of FIG. 2, wherein (alpha-solid+liquid) or (beta-solid+liquid) binary phases coexist along respective liquidus lines. However, in a ternary phase diagram, liquidus projections may not be lines but rather two-dimensional surfaces including one or more contours whereat a surface intersection of three phases (e.g., alpha-solid+beta-solid+liquid) may coexist. They may also be used to detect triple-point ternary eutectic intersections, e.g., by using the liquid phase composition at the lowest temperature isotherm to trace the eutectic alloy composition.

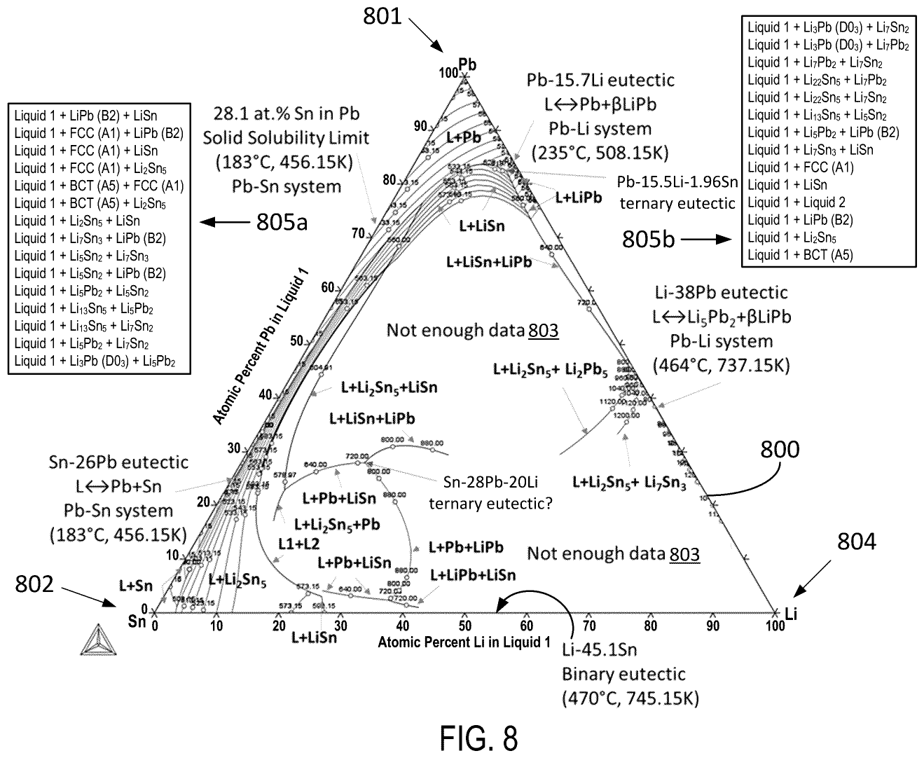

A liquidus projection plot 800 of the Pb—Li—Sn system was calculated and is presented in FIG. 8. Isothermal liquidus lines indicate equilibrium phases [liquid(s)+solid(s)] that are stable along liquidus lines with varying composition and fixed temperature. In the plot 800, various alloys or other species which may include atomic percentages indicated by corresponding axes in the plot 800 are tabulated in a box 805. The plot 800 depicts solid solutions of Pb and Sn in equilibrium with liquid (e.g., L+Pb and L+Sn) at the Pb-rich corner 801 and Sn-rich corner 802. Moving away from the Pb-and Sn-rich corners 801 and 802 (e.g., increasing Li %), liquidus areas where L+intermetallic (e.g., liquid in equilibrium with Li₂Sn₅, LiSn, and/or LiPb) are in thermodynamic equilibrium may be observed. Continuing on, fewer liquidus lines may be observed as the database proves less satisfactory for predictions of more complex compounds. Large, empty regions are present in the central portion 803 of the plot 800, as well as in the Li-rich corner 804, where the lack of experimental data on the Pb—Li—Sn system may limit the modeling.

Selected equilibrium points from binary systems are highlighted in FIG. 8, including Pb—Li, Pb—Sn, and Li—Sn cutectics, to allow for visualization and extrapolation from binary to higher order ternary eutectics. Upon analysis, a few ternary eutectics of interest may be observed, indicated at Pb-15.5Li-1.96Sn and Sn-28Pb-20Li. The Sn-28Pb-20Li alloy may be composed of a Sn-to-Pb ratio of about 2:1 and higher Li (20 at. % Li) than Pb-17Li (17 at. % Li). In some examples, this eutectic may display improved thermophysical properties over Pb-17Li, particularly lower vapor pressure. The Pb—Li—Sn system may contain other eutectics that can be identified experimentally and which may possess similar advantageous properties in plasma confinement contexts.

Neutronics calculations may be leveraged to more precisely quantify the use of a Pb—Li—Sn alloy as a fusion device blanket and its effect on a tritium breeding ratio. In nuclear physics, a “magic number” may refer to a number of nucleons (either protons or neutrons) arranged into complete shells within the atomic nucleus of a given element. Exemplary magic numbers may include 2 (helium), 8 (oxygen), 20 (calcium), 28 (nickel), 50 (tin), and 82 (lead). Atomic nuclei consisting of such magic numbers of nucleons may have a higher average binding energy per nucleon than predictions (e.g., the semi-empirical mass formula) would indicate, and are hence more stable against nuclear decay.

Natural tin ores consist of relatively stable isotopes with the following approximate concentrations: 0.9% ¹¹²Sn, 0.6% ¹¹⁴Sn, 0.35% ¹¹⁵Sn, 14.1% ¹¹⁶Sn, 7.5% ¹¹⁷Sn, 24.0% ¹¹⁸Sn, 8.6% ¹¹⁹Sn, 33.0% ¹²⁰Sn, 4.8% ¹²²Sn, and 6.1% ¹²⁴Sn. The main decay mode of radioisotopes of Sn with Z<114 (e.g., ¹¹³Sn) may include positron emission (β⁺); for Sn isotopes with Z>120 (e.g., ¹²¹Sn, ¹²³Sn, and ¹²⁵Sn), decay may be common by electron emission (β⁻). Some radioisotopes produced by either (n,γ) or (n,n) reactions with Sn may be relatively short lived (<0.5 year), except for ^{121m}Sn with t_{1/2} of ˜44 years (β⁻E: 0.42 MeV). Neutron interactions that produce gamma-rays may have periods not exceeding 40 minutes with energies below 35 keV, except for ¹²⁵Sn with t_{1/2} of ˜9.52 minutes (γE: 1.86 MeV). α-particle nuclides may be absent in the radioactive waste of tin, making it less radiotoxic than other dense metals used in nuclear applications such as Pb and Bi.

In nuclear physics, the concept of neutron cross-section (σ) may be used to express the likelihood of interaction between an incident neutron and a target nucleus. Table 2 includes selected properties and neutron cross-sections for Li, Pb, and Sn, among others. First, it may be observed that tin's thermal neutron (˜0.025 eV, 2200 m/sec) total microscopic cross-sections (σₜₒₜ=σ_{abs}+σ_{scat}) may be in the same order of magnitude as lead's, meaning no significant difference in neutron absorption and scattering behavior would be expected when lead is substituted by tin in an alloy.

TABLE 2
Selected characteristics and neutron cross-sections.

| | | | | Microscopic cross- | | | | |
|---|---|---|---|---|---|---|---|---|
| | | | | section, σ, barns | | | Macroscopic cross- | |
| | | | | (10⁻²⁴ cm²) | | | section, Σ, cm⁻¹ | |
| Element | Atomic | Atomic | | (thermal neutrons, | | | (thermal neutrons, | |
| (isotopic | number, | weight, | Density, | 0.025 eV) | | | 0.025 eV) | |
| composition) | A | Z | ρ, g/cc | σ_{abs} | | σ_{scat} | Σ_{abs} | Σ_{scat} |
| Natural Li | 3 | 6.940 | 0.534 | 71 | | 1.4 | 3.29 | 0.065 |
| (7% ⁶Li, | | | | | | | | |
| 93% ⁷Li) | | | | | | | | |
| ⁶Li | 3 | 6 | | 945 | (n, α) | | | |
| ⁷Li | 3 | 7 | | 0.033 | (n, γ) | | | |
| Natural Pb | 82 | 207.21 | 11.35 | 0.170 | | 11 | 0.006 | 0.363 |
| (1.4% ²⁰⁴Pb, | | | | | | | | |
| 24.1% ²⁰⁶Pb, | | | | | | | | |
| 22.1% ²⁰⁷Pb, | | | | | | | | |
| 52.4% ²⁰⁸Pb) | | | | | | | | |
| ²⁰⁸Pb | 82 | 208 | | 0.00023 | (n, γ) | | 0.00078 | 0.372 |

| | | | | | | | |
|---|---|---|---|---|---|---|---|
| Natural Sn | 50 | 118.70 | 7.17 | 0.625 | 4 | 0.021 | 0.132 |
| Zr | 40 | 91.22 | 6.51 | 0.185 | 8 | 0.008 | 0.338 |
| B | 5 | 10.81 | 2.34 | 755 | 4 | 103 | 0.346 |

Comparing the macroscopic thermal neutron cross-section, Σ=σ(ρ·N_{A}/A) (where N_{A} is Avogadro's number and variables are indicated in Table 2), of tin to other nuclear energy device materials, the following observations may be made: a) Sn displays the same order of magnitude of total macroscopic cross section, Σₜₒₜ, as Zr metal (zirconium may be considered a relatively “transparent” material to neutrons due to its low σ_{abs}, hence its use as uranium fuel rod cladding material in fission reactors); and b) Sn may be ˜5,000 times less likely to absorb a neutron than B (boron may be a strong neutron absorbing material; B₄C ceramic may be used as a control rod material in certain reactors and nuclear energy devices, for example).

Materials with neutron multiplication characteristics, for example those that can undergo (n,2n) reactions such as Be and Pb (see below), may be suitable fuel breeding blanket materials for fast neutron breeding devices and thermonuclear fusion devices.

$$\begin{matrix}{}_{82}^{208} Pb + {}_{0}^{1} n \to {}_{82}^{207} Pb + 2 {}_{0}^{1} n & ( threshold = 7.4 MeV ) \\ {}_{4}^{9} Be + {}_{0}^{1} n \to 2 {}_{2}^{4} He + 2 {}_{0}^{1} n & ( threshold = 2.5 MeV )\end{matrix}$$

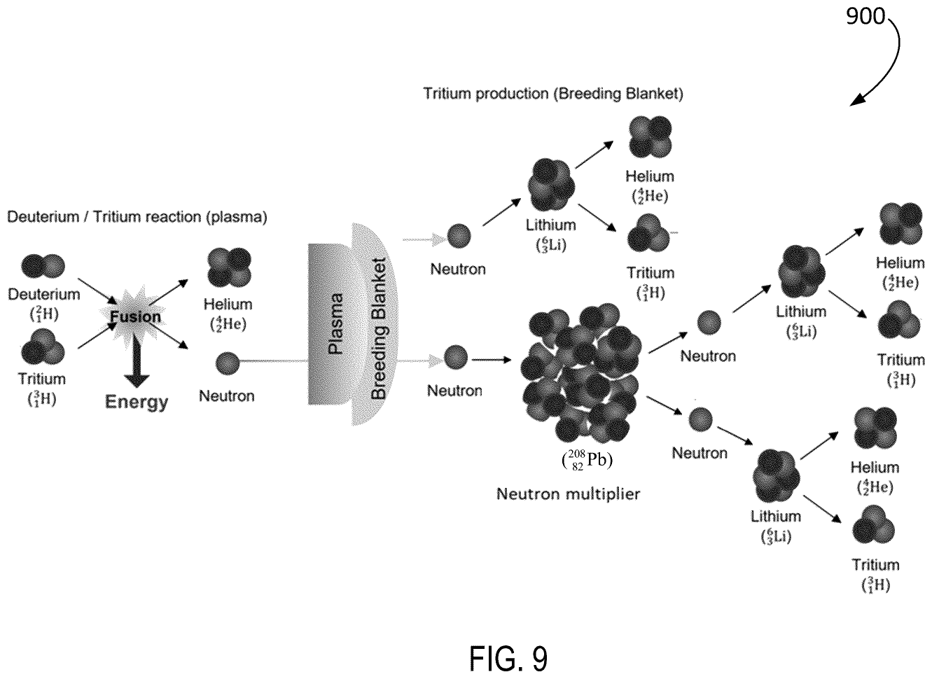

To show where the neutron multiplying materials fit in the neutron chain of events, FIG. 9 depicts a schematic 900 of certain nuclear interactions included in thermonuclear fusion and T-breeding.

From left to right in the schematic 900, first, during the thermonuclear reaction, deuterium (²H) and tritium (³H) may be fused together to form an alpha-particle (He-nucleus) and a fast neutron that may be ejected with relatively high kinetic energy:

$${}_{1}^{2} H + {}_{1}^{3} H \to {}_{2}^{4} He ( 3.52 MeV ) + {}_{0}^{1} n ( 14.06 MeV ) = ( total kinetic energy = 17.58 MeV )$$

The fast neutron may reach the blanket (e.g., Pb-17Li) and diffuse through it where the following reactions may take place (starting from highest neutron energy and highest probability):
a) the neutron may be captured by ²⁰⁸Pb to react and produce 2 more neutrons (neutron multiplication):

$${}_{82}^{208} Pb + {}_{0}^{1} n \to {}_{82}^{207} Pb + 2 {}_{0}^{1} n \qquad ( threshold = 7.4 MeV )$$

b) the neutron may undergo an endothermic reaction where it reacts with ⁷Li to produce more ³H, plus an alpha-particle and a slower neutron:

$${}_{3}^{7} Li + {}_{0}^{1} n \to {}_{2}^{4} He + {}_{1}^{3} H + {}_{0}^{1} n \qquad ( threshold = 7.4 MeV )$$

c) the neutron (or secondary neutrons) may lose enough energy through elastic scattering until it reacts with ⁶Li to produce more tritium, plus an alpha-particle:

$${}_{3}^{6} Li + {}_{0}^{1} n \to {}_{2}^{4} He + {}_{1}^{3} H + ( 4.86 MeV )$$

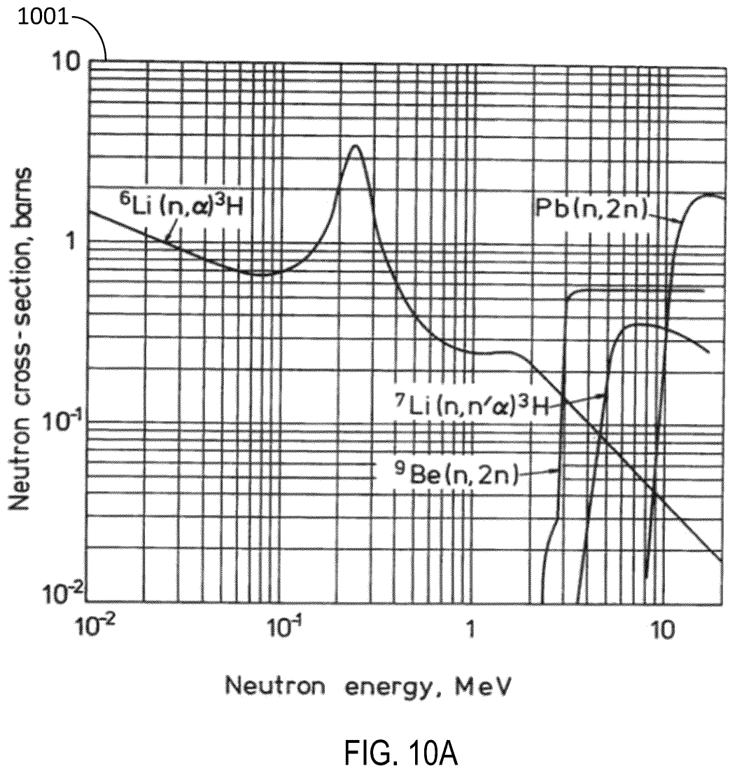

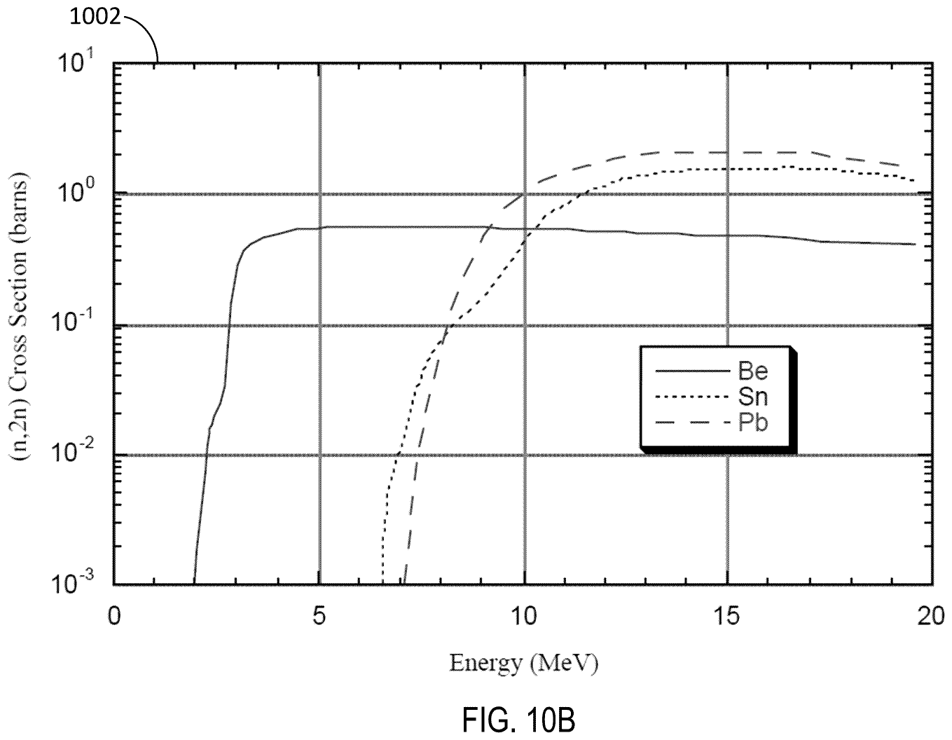

All these reactions (and other secondary or tertiary reactions) may happen substantially simultaneously under a flux of neutrons; however, the likelihood of a reaction taking place during a neutron interaction may be related to the neutron energy (E) and the neutron cross section (σ) as shown in a plot 1001 depicted in FIG. 10A. For example, the ˜14.1 MeV neutron resulting from D-T fusion may preferentially react with lead at energies above 10 MeV [(n,2n) reaction peak at σ=2.8 barns and 14 MeV]. Then neutrons with energies within the 4.5 MeV<E<10 MeV range might most probably react with ⁷Li MeV [⁶Li(n,n′α)³H reaction peak at σ=0.48 barns and 7 MeV]. As neutrons lose energy through absorption and scattering (or slower neutrons are produced from reactions with ²⁰⁸Pb and ⁷Li), the T-breeding reaction with ⁶Li may dominate at neutron energies below 4.5 MeV. The ⁶Li(n,α)³H may have a relatively wide energy range and high cross section (σ=3.5 b; 230 keV).

Tin's (n,2n) reaction spectrum may be almost identical to Pb's (n,2n) reaction spectrum as seen in a plot 1002 depicted in FIG. 10B. They both cover a similar neutron energy spectrum and slightly differ in neutron cross-section (σₛₙ=1.52 b and σ_{Pb}=2.08 b for 14 MeV neutron). This may further validate the interchangeability of Sn and Pb and viability of utilization of a Sn—Pb—Li alloy blanket.

Furthermore, to evaluate the viability of Sn as a tritium breeding blanket constituent, some comparisons are provided hereinbelow. It may be observed that when using 90% enriched lithium (⁶Li isotope rich), a Sn-25Li alloy displays about 78% of the tritium breeding ratio (TBR) capability of a Pb-17Li alloy with enriched Li and about 74% of the TBR capability of pure natural lithium, showing that Sn may be a viable blanket material. However, enrichment of lithium may be avoided since it may add to the overall cost of refueling and may further increase the Q-value needed for engineering breakeven of the system (as such enrichment processes may be energy intensive).

In some embodiments, a ternary alloy (e.g., a ternary eutectic alloy) may have a composition of PbₓLi_{y}Sn_{z}, wherein 0.1≤x≤0.3, 0.1≤y≤0.4, and 0.4≤z≤0.7. In additional or alternative embodiments, other post-transition metals (e.g., besides Sn and/or Pb, or in addition thereto) which may wholly or partially substitute Sn in PbₓLi_{y}Sn_{z}, or which may be present in other alloys described herein, may include, for example, In, Ga, and/or Tl, given the nature of chemical properties of such post-transition metals and the proximal location to both Sn and Pb on the periodic table. In additional or alternative embodiments, the ternary alloy may include one or more liquid metals, alloys, or salts used as coolants in nuclear applications, such as Na, K, a Na-78K alloy, Bi, a Bi-43.7Pb eutectic (e.g., cutectic alloy), Hg, Be, FLiBe [e.g., a liquifiable salt made from a mixture of lithium fluoride (LiF) and beryllium fluoride (BcF₂)], and the like.

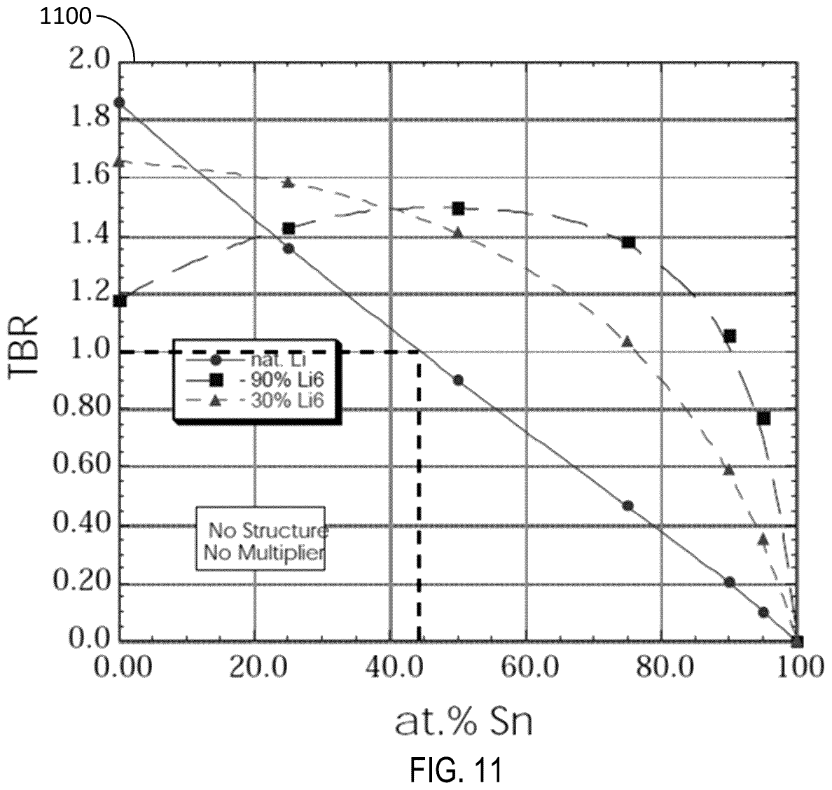

FIG. 11 shows a plot 1100 illustrating the effect of increasing Sn concentration on the TBR for natural-Li, and 60% and 90% enriched lithium. It may be observed that for Li—Sn alloys with Sn<45%, a TBR>1 may be expected, even when natural Li is considered. This may be of relevance since such alloys may provide a target of max concentration of Sn in a binary Sn—Li alloy that may display T-breeding characteristics. Accordingly, certain compositions within the Pb—Li—Sn system may possess suitable T-breeding characteristics for use as a liquid blanket for tritium breeding.

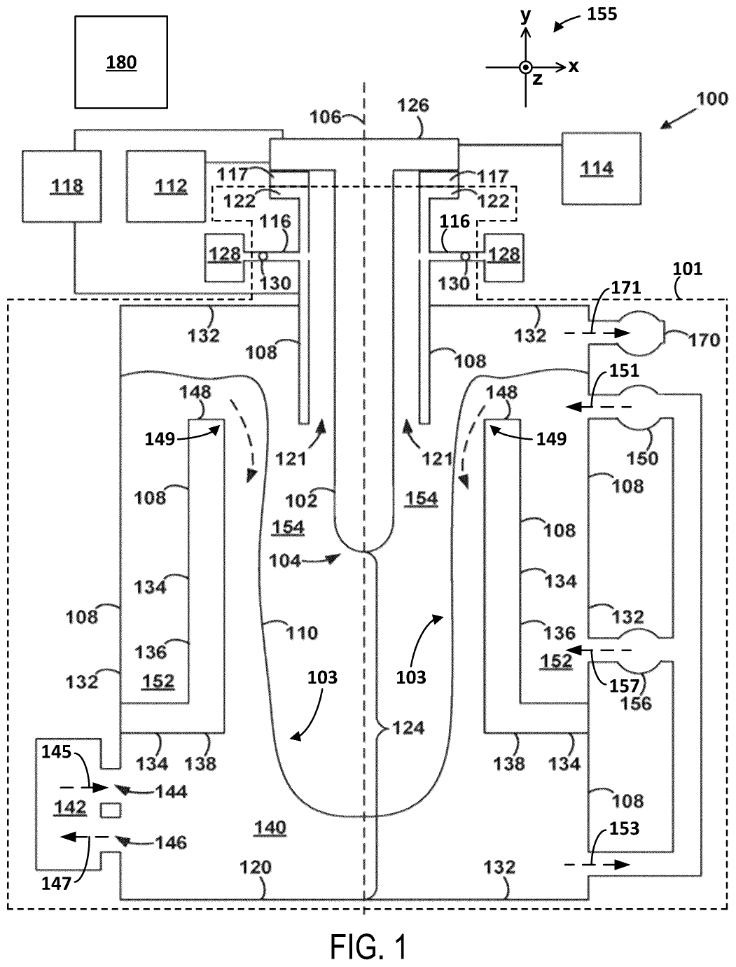

FIG. 1 depicts a schematic cross-sectional diagram of a plasma confinement system 100. In some embodiments, the plasma confinement system 100 may be configured in a thermonuclear fusion energy system, device, reactor, power plant, or other such apparatus or system. In additional or alternative embodiments, the plasma confinement system may be one reactor core of a plurality of reactor cores included in such a thermonuclear fusion energy system. In an exemplary embodiment, the plasma confinement system 100 may be configured as a SFS Z-pinch reactor core.

The plasma confinement system 100 may include an inner electrode 102 having a rounded first end 104 that is disposed on a longitudinal axis 106 (e.g., an axis of cylindrical symmetry) of the plasma confinement system 100. The plasma confinement system 100 may further include an outer electrode 103 that at least partially surrounds the inner electrode 102. In some embodiments, the outer electrode 103 may include a solid conductive shell 108 and an electrically conductive material 110, such as a cutectic alloy 110, disposed on the solid conductive shell 108 and on the longitudinal axis 106 of the plasma confinement system 100. In at least one embodiment, the eutectic alloy 110 may include any one or more electrically conductive materials discussed in detail above with reference to FIGS. 2-11. In an exemplary embodiment, the eutectic alloy 110 may have a melting point inclusive of liquid metals and salts used in nuclear applications. As an example, the cutectic alloy 110 may have a melting point within a range of −40° C. to 450° C. at 1 atmosphere of pressure. As another example, the eutectic alloy 110 may have a melting point within a range of −40° C. to 400° C. at 1 atmosphere of pressure. As yet another example, the eutectic alloy 110 may have a melting point within a range of 35° C. to 330° C. at 1 atmosphere of pressure. Accordingly, in at least one example, the eutectic alloy 110 may have a liquid composition, e.g., be at least partially in a liquid state, under one or more operating conditions of the plasma confinement system 100. In various examples, the eutectic alloy 110 can take the form of cutectics, alloys, or mixtures of one or more of lithium, lead, or tin. In at least one embodiment, the eutectic alloy 110 may be an alloy including at least Li and Pb and which is at least partially in a liquid state under one or more operating conditions of the plasma confinement system 100. For example, the cutectic alloy 110 may have a composition of PbₓLi_{y}Sn_{z}, wherein x, y, and z may include positive values (e.g., which sum to 1). The eutectic alloy 110 may be homogeneous during operation of the plasma confinement system 100 (e.g., the eutectic alloy 110 may remain homogeneous under one or more operating conditions of the plasma confinement system 100) and/or include one or more metals including an atomic radius within 15% of an atomic radius of another metal in the eutectic alloy 110, at least some crystal lattice affinity, >96% metallic bonding, and/or a melting point within 150° C. of a melting point of each other metal in the eutectic alloy 110. In at least one embodiment, the one or more operating conditions may include a temperature level of >700° C. and/or a vacuum level of <10⁻⁶ Torr.

The inner electrode 102 may take the form of an electrically conducting shell (e.g., formed of one or more of stainless steel, molybdenum, tungsten, or copper) having a substantially cylindrical body. As an example, the inner electrode 102 may include a first end 104 (e.g., a rounded end) and an opposing second end 126 (e.g., a substantially disc-shaped end). The first end 104 may be formed of a carbon-based material such as graphite or carbon fiber, or one or more of stainless steel, molybdenum, tungsten, or copper, for example. In some embodiments, the inner electrode 102 has a coating on its outer surface that includes a eutectic alloy or other electrically conductive material having a melting point within a range of 180° C. to 800° C. (e.g., 180° C. to 550° C.) at 1 atmosphere of pressure. In various examples, the electrically conductive material can take the form of cutectics, alloys, or mixtures of one or more of lithium, lead, or tin. Alternatively, the electrically conductive material can take the form of elemental lithium, lead, or tin. In at least one embodiment, the electrically conductive material may have the same composition as the eutectic alloy 110.

The plasma confinement system 100 may further include a feeding mechanism 112 (e.g., an electromechanical system) that may be configured to move the inner electrode 102 in or out of the plasma confinement system 100 along the longitudinal axis 106. During operation, the inner electrode 102 may become eroded by plasma discharge and the feeding mechanism 112 may be operated to feed in the inner electrode 102 and other components of the plasma confinement system 100.

The plasma confinement system 100 may further include a cooling system 114 (e.g., a heat exchanger) that is configured to cool the inner electrode 102 during operation of the plasma confinement system 100.

The outer electrode 103 may take the form of an electrically conducting (e.g., stainless steel) shell having a substantially cylindrical body. The solid conductive shell 108 of the outer electrode 103 may include a solid conductive outer shell 132 and a solid inner shell 134 (e.g., formed of an electrically conductive material and/or a high-resistivity material such as silicon carbide) that may be disposed within the solid conductive outer shell 132 and may be in contact with the solid conductive outer shell 132. More specifically, the solid inner shell 134 may include an axial wall 136 that at least partially encircles the longitudinal axis 106 of the plasma confinement system 100 (e.g., partially encircles the inner electrode 102) and a radial wall 138 that couples the axial wall 136 to the solid conductive outer shell 132.

The outer electrode 103 may include a first end 120 and an opposing second end 122. The rounded first end 104 of the inner electrode 102 may be between the first end 120 (e.g., a substantially disc-shaped end) of the outer electrode 103 and the second end 122 (e.g., a substantially annular end) of the outer electrode 103. The radial wall 138 and a first end 120 of the outer electrode 103 may form a pool region 140 within the plasma confinement system 100. The pool region 140 may serve as a reservoir for a substantial amount of the (e.g., liquid) cutectic alloy 110 that is in the plasma confinement system 100. An end 148 of the axial wall 136 may face the second end 122 of the outer electrode 103. The end 148 may include an edge 149 circumscribing the inner electrode 102. As shown, the eutectic alloy 110 may also be circulated over the end 148 of the axial wall 136 by a pump 150 and/or a pump 156 as is discussed in more detail below. In certain embodiments, and as shown in FIG. 1, the edge 149 may be configured as two surfaces meeting at a 90° angle. In other embodiments, the edge 149 may be rounded (e.g., to facilitate the eutectic alloy 110 flowing toward the pool region 140).

The outer electrode 103 (e.g., the solid conductive shell 108 and the cutectic alloy 110) may surround much of the inner electrode 102. The inner electrode 102 and the outer electrode 103 may be concentric and have radial symmetry with respect to the longitudinal axis 106. In some embodiments, the inner electrode 102 may have a length (e.g., parallel with the y-axis and between the first end 104 and the second end 126) ranging from 25 cm to 1 m or more and a radius (e.g., parallel with the x-axis) ranging from 2 cm to 1 m, and the outer electrode 103 may have a length (e.g., parallel with the y-axis and between the first end 120 and the second end 122) ranging from 50 cm to 6 m, a radius (e.g., parallel with the x-axis) ranging from 6 cm to 2 m or more, and an annular thickness (e.g., along the x-axis) ranging from 6 mm to 12 mm.

The plasma confinement system 100 also may include a heat exchanger 142, a first port 144 configured to guide the eutectic alloy 110 from the heat exchanger 142 into the pool region 140, and a second port 146 configured to guide the eutectic alloy 110 from the pool region 140 to the heat exchanger 142. The heat exchanger 142 may be configured to receive 147, via the second port 146, the eutectic alloy 110 that may be heated within the plasma confinement system 100, extract heat from the eutectic alloy 110, and move 145 (e.g., pump) the cutectic alloy 110 back into the pool region 140 via the first port 144 to be heated again by fusion reactions that take place in the plasma confinement system 100. In additional or alternative embodiments, the heat exchanger 142 may be configured as a steam generator and/or fuel recycling system, e.g., which may function to extract thermal energy from the eutectic alloy 110 cycling therethrough.

The plasma confinement system 100 may also include a first pump 150 configured to pump 153 the cutectic alloy 110 from the pool region 140 and expel 151 the eutectic alloy 110 to a region 152 that is outside the axial wall 136 and separated from the pool region 140 by the radial wall 138. The first pump 150 may be configured to move the eutectic alloy 110 over the end 148 of the axial wall 136 to a region 154 inside the axial wall 136.

The plasma confinement system 100 also may include a second pump 156 configured to pump 153 the eutectic alloy 110 from the pool region 140 and expel 157 the eutectic alloy 110 to the region 152 that is outside the axial wall 136 and separated from the pool region 140 by the radial wall 138.

The plasma confinement system 100 may also include a pump 170 (e.g., a turbo-molecular pump) configured to pump 171 air out of the plasma confinement system 100 such that the base pressure within the plasma confinement system 100 is within the range of 10⁻³ to 10⁻⁹ Torr. In certain embodiments, the plasma confinement system 100 may include a vacuum chamber 101 that at least partially surrounds the inner electrode 102 and/or the outer electrode 103. In an exemplary embodiment, the vacuum chamber 101 may entirely surround each of the inner electrode 102 and the outer electrode 103. In an example embodiment, the vacuum chamber 101 may be formed as a stainless steel pressure vessel. In some embodiments, a pressure inside the vacuum chamber 101, e.g., during operation of the pump 171) may range from 10⁻⁹ Torr to 20 Torr.

The plasma confinement system 100 may also include one or more gas ports 116 configured to direct gas (e.g., tritium, deuterium, helium-3, a boron containing gas, or borane) from a gas source 128 (e.g., a pressurized gas tank) into an acceleration region 121 that is radially between the inner electrode 102 and the outer electrode 103. The one or more gas ports 116 may direct the gas, for example, by respectively actuating one or more valves 130 positioned between the gas source 128 and the acceleration region 121. In certain embodiments, the one or more valves 130 may include at least one electrically actuated valve, such as a solenoid-driven valve. However, the one or more valves 130 are not limited to such configurations and may include any type of valve configured to direct gas from the gas source 128 (e.g., from outside the outer electrode 103) to the acceleration region 121. For example, in some embodiments, the one or more valves 130 may include at least one gas-puff valve (e.g., to provide neutral gas to the acceleration region 121) and/or at least one plasma injector (e.g., to provide pre-ionized gas to the acceleration region 121) installed as an array or arrays regularly distributed around a central axis of the acceleration region 121 (e.g., along the outer electrode 103). The acceleration region 121 may have a substantially annular cross section defined by the shapes of the inner electrode 102 and the solid conductive shell 108. As shown in FIG. 1, the one or more gas ports 116 may be positioned axially between the first end 104 of the inner electrode 102 and the second end 126 of the inner electrode 102.

The plasma confinement system 100 may also include a power supply 118 configured to apply a voltage between the inner electrode 102 and the outer electrode 103 (e.g., the solid conductive shell 108). The power supply 118 may take the form of a capacitor bank capable of storing up to 500 kJ to up to 3-4 MJ, for example. A positive terminal of the power supply 118 may be coupled to the inner electrode 102 or alternatively to the outer electrode 103 (e.g., the solid conductive shell 108). In some embodiments, the power supply 118 may include a switching pulsed direct current (switching pulsed-DC) power supply including an energy source (e.g., a capacitor bank), a switch (e.g., a spark gap, an ignitron, or a semiconductor switch), and a pulse shaping network (including, e.g., inductors, resistors, diodes, and the like). In some embodiments, the power supply 118 may be voltage-controlled. In other embodiments, the power supply 118 may be current-controlled. In some embodiments, other suitable types of power supplies may be used as the power supply 118, including DC and alternating current (AC) power supplies (e.g., DC grids, voltage source converters, homopolar generators, and the like).

The plasma confinement system 100 may include an assembly region 124 within the outer electrode 103 between the first end 104 of the inner electrode 102 and the first end 120 of the outer electrode 103. In some embodiments, the acceleration region 121 may have a length (e.g., parallel with the y-axis and between the second end 122 of the outer electrode 103 and the first end 104 of the inner electrode 102) ranging from 25 cm to 1.5 m and an annular thickness ranging from 2 cm to 10 cm, and the assembly region 124 may have a length (e.g., parallel with the y-axis and between the first end 104 of the inner electrode 102 and the first end 120 of the outer electrode 103) ranging from 25 cm to 3 m. The plasma confinement system 100 may be configured to sustain a Z-pinch plasma within the assembly region 124 as described below.

The plasma confinement system 100 also may include an insulator 117 between the second end 122 of the outer electrode 103 (e.g., the solid conductive shell 108) and the inner electrode 102 to maintain electrical isolation between the inner electrode 102 and the outer electrode 103. The insulator 117 may have an annular cross section. In an example embodiment, the insulator 117 may be formed from an electrically insulating material such as a glass, a ceramic, or a glass-ceramic material. In some embodiments, one or more valves (e.g., gas-puff valves and/or plasma injectors) may extend through or be provided in place of the insulator 117 to inject neutral gas and/or pre-ionized gas at an end of the acceleration region 121 opposite to the first end 104 of the inner electrode 102.

The heat exchanger 142 may receive 147 (e.g., pump), via the second port 146, a portion of the eutectic alloy 110 that may be heated within the plasma confinement system 100, extract heat from the eutectic alloy 110, and move 145 (e.g., pump) the eutectic alloy 110 back into the pool region 140 via the first port 144 to be heated again by fusion reactions that take place in the plasma confinement system 100. Prior to forming a plasma discharge within the plasma confinement system 100, the eutectic alloy 110 may be heated (e.g., melted) into a liquid state using a (e.g., electric) heating element disposed within the plasma confinement system 100.

The plasma confinement system 100 may include a feeding mechanism 112 (e.g., an electromechanical system) that can move the inner electrode 102 in or out of the plasma confinement system 100 along the longitudinal axis 106. During operation, the inner electrode 102 may become eroded by plasma discharge and the feeding mechanism 112 may be operated to feed the inner electrode 102 and other components of the plasma confinement system 100.

In addition, the pumps 150 and 156 may move or circulate the eutectic alloy 110 over the solid conductive shell 108 so that different portions of the eutectic alloy 110 may be used to absorb current and/or heat (e.g., at the longitudinal axis 106) from the Z-pinch plasma over time. During operation of the plasma confinement system 100, much or all of the eutectic alloy 110 may be in a liquid state.

In some embodiments, the pumps 150 and 156 may move the eutectic alloy 110 such that the eutectic alloy 110 moved over the solid conductive shell 108 may be moved in an azimuthal direction (e.g., around the longitudinal axis 106) and/or an axial direction with respect to the longitudinal axis 106 of the plasma confinement system 100.

More specifically, the pumps 150 or 156 may move the eutectic alloy 110 from the pool region 140 to the region 152 that is outside the axial wall 136 and separated from the pool region 140 by the radial wall 138. Additionally, the pumps 150 or 156 may move the eutectic alloy 110 over the end 148 of the axial wall 136 to the region 154 inside the axial wall 136, and back toward the pool region 140.

In various embodiments, the voltage applied between the inner electrode 102 and the outer electrode 103 (e.g., the solid conductive shell 108) may be, in some examples, within a range of 2 kV to 50 kV or, in additional or alternative examples, within a range of 1 kV to 40 kV. The voltage applied between the inner electrode 102 and the outer electrode 103 (e.g., the solid conductive shell 108) may result in a radial electric field within a range of 30 k V/m to 500 kV/m.

In some embodiments, the Z-pinch plasma may have a radius between 0.1 mm and 5 mm, an ion temperature between 900 and 50,000 eV, and/or an electron temperature greater than 500 cV (e.g., up to 50,000 eV). The Z-pinch plasma may have an ion number density greater than 1×10²³ ions/m³ and/or an electron number density greater than 1×10²³ electrons/m³, and/or may exhibit sheared flow, e.g., with a magnetic field of over 8 T. The Z-pinch plasma may exhibit stability for at least 10 μs (e.g., up to 1 ms or more). It should be noted that such ranges are exemplary and may be modified based on an operating mode of the plasma confinement system 100 or based on modifications to a size, function, configuration, etc. of the plasma confinement system 100. For example, if the size of the plasma confinement system 100 increases, such ranges may scale proportionally (e.g., linearly, exponentially, etc.).

In some embodiments, the reaction products of the Z-pinch plasma may include neutrons. As such, during operation of the plasma confinement system 100, neutrons and a portion of the cutectic alloy 110 may be consumed to generate additional tritium fuel for recovery as the heat exchanger 142. The reactive nature of the eutectic alloy 110 may also serve to reduce the base pressure within the plasma confinement system 100 by capturing vapor particles.

Some embodiments may include controlling a thickness of the eutectic alloy 110 on the solid conductive shell 108 by adjusting a rate at which the heat exchanger 142 moves the eutectic alloy 110 into the pool region 140. Increasing the rate at which the eutectic alloy 110 flows into the pool region 140 may increase a thickness of the eutectic alloy 110 on the solid conductive shell 108. Increasing the rate at which the eutectic alloy 110 flows out of the pool region 140 to the heat exchanger 142 may decrease the thickness of the eutectic alloy 110 on the solid conductive shell 108.

In additional, alternative, or otherwise modified embodiments to those described above and in detail below with reference to FIG. 1, one or more components of the plasma confinement system may be added, removed, substituted, modified, or interchanged to adapt the plasma confinement system 100 for a given use case. As an example, a plasma may be directly injected into a plasma confinement chamber (e.g., a combined volume of the acceleration region 121 and the assembly region 124) of the plasma confinement system, e.g., in addition to or instead of intrachamber conversion of fuel gas species to the plasma. Further, though various embodiments described herein are discussed with reference to Z-pinch plasma confinement, the various embodiments, with or without modification, may be applicable to other types of thermonuclear fusion devices and plasma confinement systems which compress, react, or otherwise use plasma.

For example, the plasma confinement system 100 may include one or more first valves (e.g., the one or more valves 130) configured to direct gas from within the inner electrode 102 to the acceleration region 121 and one or more second valves (not shown at FIG. 1) configured to direct gas from outside the outer electrode 103 to the acceleration region 121. The gas may be a fuel gas, which may be utilized to form a plasma arc upon release of the gas into the plasma confinement chamber and application of a discharge current. As used herein, “fuel gas” may refer to any species utilized to form the plasma arc. As such, the fuel gas may include neutral gas species, such as including dihydrogen [e.g., hydrogen (H₂), deuterium (D₂), and/or tritium (T₂)], other protium-, deuterium-and/or tritium-containing species, ³He, ⁶Li, ¹¹B, borane, etc., and/or pre-ionized gas species (e.g., such as introduced via “direct plasma injection” or “plasma injection” configurations).

In at least one embodiment, an acceleration volume (e.g., corresponding to the acceleration region 121) may be increased relative to that of certain other Z-pinch plasma devices and arranged to be filled by a gas mixture (e.g., a neutral working gas mixture) via at least one internal valve, such as at least one gas-puff valve (to provide neutral gas to the acceleration volume) and/or plasma injector (to provide pre-ionized gas to the acceleration volume), arranged substantially along a central axis of the acceleration volume (e.g., the longitudinal axis 106). Additionally or alternatively, a plurality of external valves, such as a plurality of gas-puff valves (to provide neutral gas to the acceleration volume) and/or plasma injectors (to provide pre-ionized gas to the acceleration volume), may be installed as a regular array on an external vacuum boundary which may be arranged as an external, or outer, electrode.

In some embodiments, gas-puff valves and/or plasma injectors included in the one or more first valves and/or the one or more second valves may be electronically triggered to independently deliver a “puff” of filling neutral and/or pre-ionized gas for a duration lasting up to several hundred us (e.g., up to 1 ms). An amount of filling gas (also referred to herein as “fuel gas”) delivered (e.g., in the “puff”) may also be controlled by adjustments of a filling gas pressure supplied to the gas-puff valves and/or plasma injectors (e.g., to individual or all of the gas-puff valves and/or plasma injectors or subsets thereof). In addition, different gas-puff valves and/or plasma injectors (or different combinations of multiple gas-puff valves and/or plasma injectors) may be fed by different fill gas mixtures having, for example, different elemental ratios of filling gases and/or different isotopic ratios (e.g., adjustable D₂/T₂ molecular ratios). In some embodiments, the gas-puff valves and/or plasma injectors may be uniform (e.g., all of the same type/size with substantially the same operational settings). In other embodiments, different gas-puff valves and/or plasma injectors may be used for different locations. In additional or alternative embodiments, the gas-puff valves and/or plasma injectors may control a flow of gas into the acceleration region 121 via a manifold including multiple ports providing passage into the acceleration region 121. In such embodiments, the ports of the manifold may be uniform or may vary in configuration (e.g., to deliver different amounts of gas to different locations of the acceleration region 121 when a respective gas-puff valve or plasma injector is open).

Similar to neutral gas injection via gas-puff valves, (pre-)ionized gas or plasma may be injected using combinations or manifolds of variously located plasma injectors fluidically coupled to respective plasma generators or guns which generate the plasma prior to injection into the acceleration region 121. In some embodiments, the plasma may be sourced from a gas-injected washer plasma gun and/or a plasma thruster (e.g., a Hall effect thruster or a magnetohydrodynamic thruster), or, if the plasma is magnetized, from a high-power helicon plasma source, a radio frequency plasma source, a plasma torch, and/or a laser-based plasma source. Plasmas formed from gas mixtures may also be created and injected in a manner similar to neutral gas injection. Plasma injection may provide a finer control of an eventual axial plasma distribution as well as a shear flow profile thereof, which in turn may allow for higher fidelity control of plasma stability and lifetime. Additional control of plasma injection may be provided due to the plasma particles being charged particles that may be accelerated by electric fields created by a variable electrical bias (or voltage) on injection electrodes. Thus, a speed of the injected plasma may be finely controlled to allow for fine adjustment and optimization of breakdown of any neutral gas present (e.g., in the acceleration region 121). Moreover, the injected plasma may travel at faster velocities than injected neutral gas, which may travel in a nearly static fashion (relative to the injected plasma) during Z-pinch discharge pulses. As such, relative to neutral gas injection, plasma injection may provide pre-ionized fuel “on demand” (e.g., more immediately), for example, to replenish the fuel gas during Z-pinch discharge pulses.

In some embodiments, the pre-ionized gas may be generated as an unmagnetized plasma, e.g., so as to avoid interaction between a magnetic field of the pre-ionized gas and a magnetic field of the acceleration region 121. In other embodiments, the pre-ionized gas may be generated as a magnetized plasma, e.g., so as to align the magnetic field of the pre-ionized gas to be parallel with the magnetic field of the acceleration region 121 and/or be adjustable to provide a desired magnetic flux profile at an injection point of the pre-ionized gas.

In some embodiments, plasma to be injected into the acceleration region 121 may be generated by pre-ionizing neutral gas with a spark plug or via inductive ionization. More broadly, the gas-puff valves and/or plasma injectors may include one or more electrode plasma injectors and/or one or more electrodeless plasma injectors. In examples wherein the one or more electrode plasma injectors are included, the plasma to be injected into the acceleration region 121 may be generated, at least in part, by electrode discharge. In additional or alternative examples wherein the one or more electrodeless plasma injectors are included, the plasma to be injected into the acceleration region 121 may be generated, at least in part, by inductive discharge produced by an external coil window (e.g., a radio-frequency antenna operating at 400 kHz, 13.56 MHz, 2.45 GHZ, and/or other frequencies permitted for use in a given local jurisdiction, such as within frequency ranges permitted by the Federal Communications Commission). In some embodiments, neutral gas for pre-ionization may be limited by a configuration of a neutral gas reservoir (e.g., a gas source 128) and/or neutral gas conductance to a selected plasma injector configuration.

In some embodiments, axial distribution of the injected plasma may be ensured via an axisymmetric plasma injector configuration. In at least one embodiment, eight plasma injectors may be respectively positioned at eight equally spaced ports of the manifold. The eight ports may each be configured at an oblique angle (e.g., between 5° and 90° with respect to the central axis of the acceleration region 121) with respect to a housing of the acceleration region 121. In one example, the oblique angle may be 45° with respect to the central axis of the acceleration region 121. In some embodiments, the eight ports may be configured at a single axial position along the central axis of the acceleration region 121 (that is, the eight ports may be equally spaced about a circumference or other perimeter of the acceleration region 121 at the axial position). In other embodiments, the ports may include multiple sets of eight ports, with each set of eight ports being equally spaced about a different axial position along the central axis of the acceleration region 121. In an example embodiment, the sets of eight ports may be configured as interleaved pairs of sets, wherein a first set of eight ports may be positioned at a first axial location and a second set of eight ports may be positioned at a second, different axial location and rotated relative to the first set such that each port of the second set is positioned between a pair of ports of the first set with respect to the circumference of the acceleration region 121. Specifically, in such an embodiment, each port of the first set of eight ports may be spaced around the circumference of the acceleration region 121 every 45°, and each port of the second set of eight ports may be spaced around the circumference of the acceleration region 121 every 45° offset (rotated) from the first set of ports by 22.5°, such that one port of the first and second sets is provided around the circumference of the acceleration region 121 every 22.5°. In additional or alternative embodiments, plasma injection may be performed azimuthally, e.g., along a chord perpendicular to the central axis of the acceleration region 121, so as to generate an azimuthal flow within the acceleration region 121. In some embodiments, additional gas-puff valves and/or plasma injectors may be included to allow for injection of more fuel gas (e.g., for longer lasting pinch discharges) and control of an axial pressure distribution of the fuel gas in the acceleration region 121 (e.g., for additional enhancement of the sheared ion velocity flow duration). In additional or alternative embodiments, the valves may be configured differently (e.g., asymmetrically distributed azimuthally and/or with different angular distributions) with other variations to achieve a substantially equivalent profile by compensating for effects of the variations.

In some embodiments, injecting the acceleration region 121 with pre-ionized gas may result in plasmas having a plasma temperature in a range of 1 to 10 eV. The plasma temperature may be decreased (e.g., by reducing an amount of energy input into a process gas used to generate the pre-ionized gas) so as to increase an electrical resistivity of the pre-ionized gas and resulting plasma. Specifically, increasing the electrical resistivity may decrease a tendency of the pre-ionized gas to oppose changes in magnetic flux and thereby a tendency to oppose motion within a magnetic field present in the acceleration region 121.

As noted above, because an injection velocity of pre-ionized gas may be significantly greater than that of neutral gas, a velocity of the plasma within the acceleration region 121 may be up to 50×10³ m/s. In some embodiments, injection of pre-ionized gas may provide flexibility in an amount of particles injected. Specifically, in an example embodiment, an amount of pre-ionized gas particles may be injected in 1/50 of a time utilized to inject the same amount of neutral gas particles. For example, an amount of time utilized to inject 10 Torr-L of neutral gas particles (where 1 Torr-L is proportional to 2.5×10¹⁹ molecules at 273 K) may be the same amount of time utilized to inject 500 Torr-L of pre-ionized gas particles. Similarly, in some embodiments, an injection rate (or mass flow rate) of pre-ionized gas may be varied according to power supply current and voltage (that is, a waveform of an injection pulse). As an example, increasing the power supply voltage (e.g., to between 100 V and 500 V) may concomitantly increase the injection velocity. As another example, increasing the power supply current (e.g., to between 1 A and 500 A) may concomitantly increase the injection rate. In some embodiments, the power supply voltage may be increased to between 750 V and 5 kV.

As discussed above, the gas-puff valves and/or plasma injectors may be activated either individually or in groups. An initial gas load inside the acceleration region 121 having desired axial and azimuthal profiles may be achieved by timing individual valves and/or groups of valves. Such valves (or groups thereof) may be timed in a fashion to align an arrival of the neutral and/or pre-ionized gas and/or mixtures thereof to a desired initial profile. Power supplies (e.g., power supply 118 and/or separate, dedicated power supplies) may be timed to achieve ionization at a desired axial location and utilize the initial gas load to produce and sustain the sheared flow. In some embodiments, the power supplies may include a capacitor bank and a switch. In other embodiments, other suitable types of power supplies may be used, including flywheel power supplies.

Various combinations of (neutral gas) gas-puff valves with plasma injectors may be activated to achieve a desired level of power output. Moreover, plasma may be injected into the acceleration region 121 significantly (e.g., ˜100×) faster than puffed neutral gas. A combination of such different injection speeds allowed by acceleration of plasma injection with neutral gas injection provides an even larger parameter space for optimization. Additionally, plasma injectors may serve to inject mass and precisely control locations of neutral gas ionization.

Injection of neutral gas in particular may be accomplished through puff valves and/or through release of hydrogen gas from a metal hydride, e.g., titanium deuteride (TiD₂) or other metal hydrides based on scandium, vanadium, or other metals.

The plasma confinement system 100 may include a controller or other computing device 180, which may include non-transitory memory on which executable instructions may be stored. The executable instructions may be executed by one or more processors of the controller 180 to perform various functionalities of the plasma confinement system 100. Accordingly, the executable instructions may include various routines for operation, maintenance, and testing of the plasma confinement system 100. The controller 180 may further include a user interface at which an operator of the plasma confinement system 100 may enter commands or otherwise modify operation of the plasma confinement system 100. The user interface may include various components for facilitating operator use of the plasma confinement system 100 and for receiving operator inputs (e.g., requests to generate plasma arcs for thermonuclear fusion, etc.), such as one or more displays, input devices (e.g., keyboards, touchscreens, computer mice, depressible buttons, mechanical switches other mechanical actuators, etc.), lights, etc. The controller 180 may be communicably coupled to various components (e.g., valves, power supplies, etc.) of the plasma confinement system 100 to command actuation and use thereof (wired and/or wireless communication paths between the controller 180 and the various components are omitted from FIG. 1 for clarity).

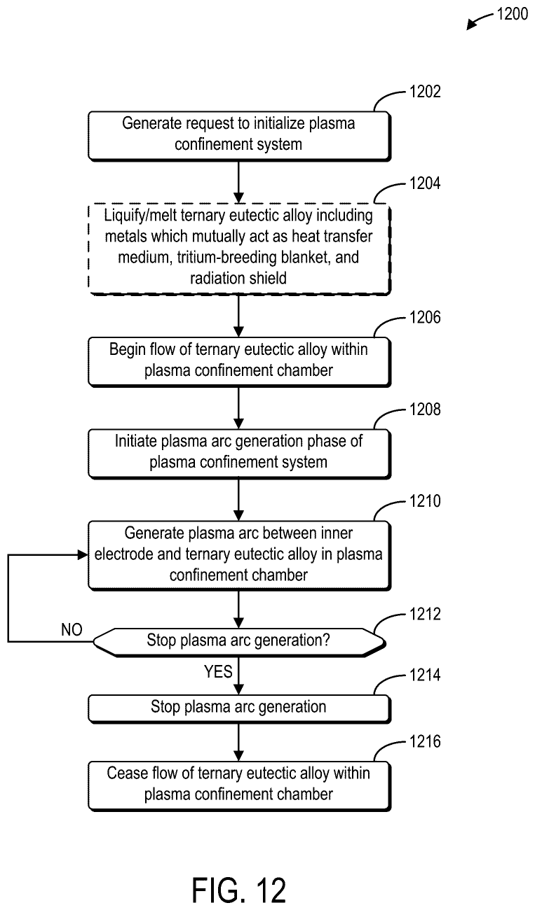

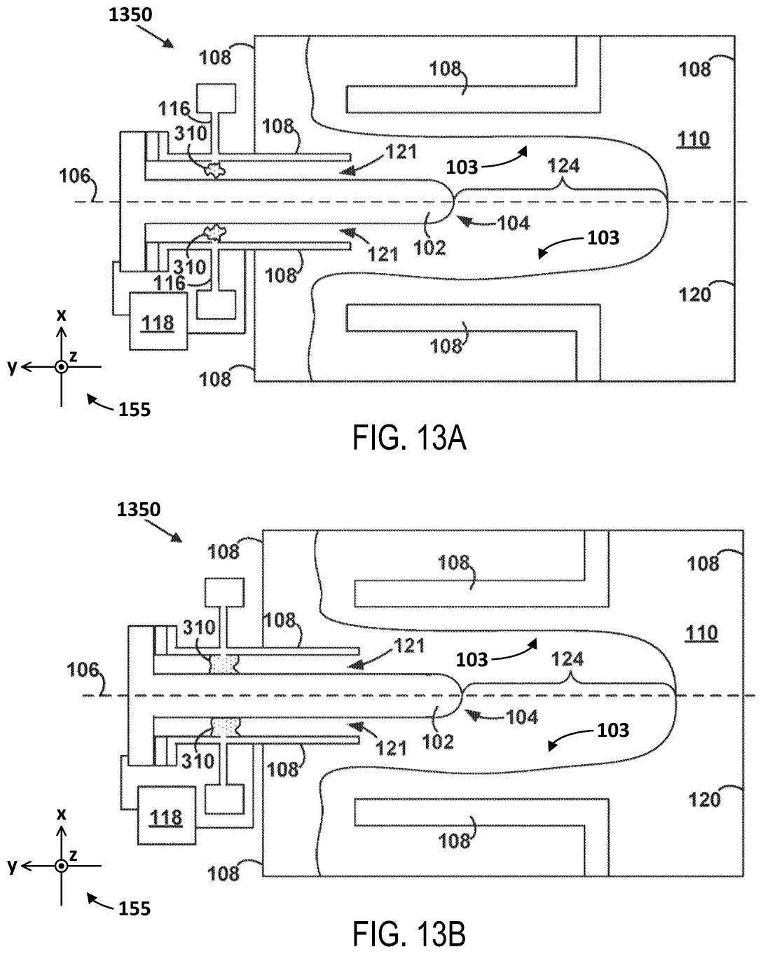

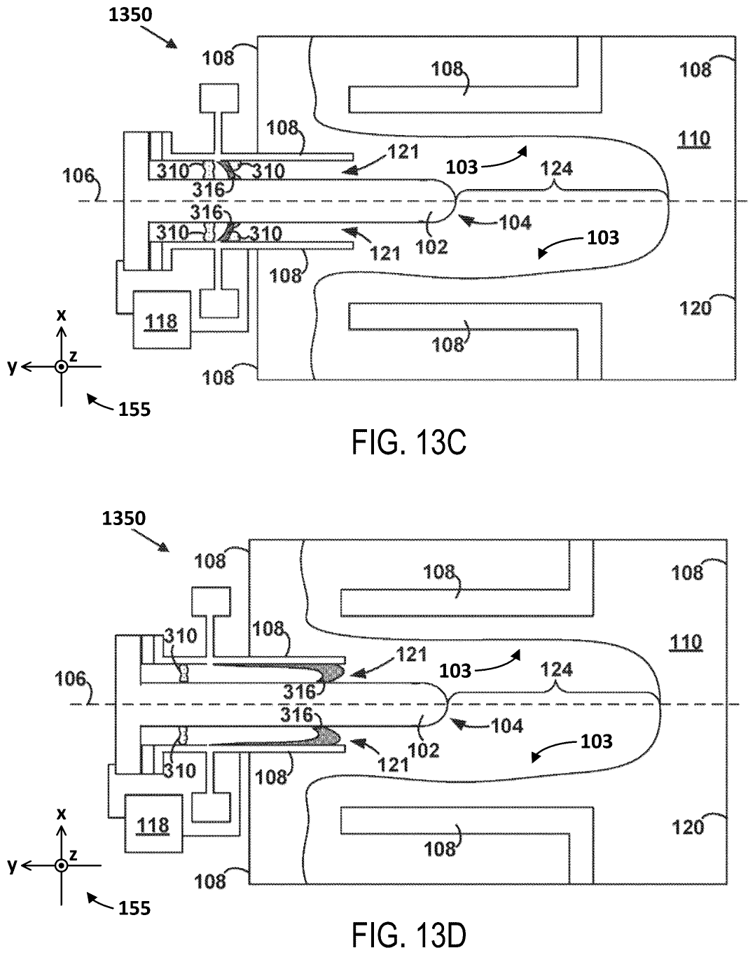

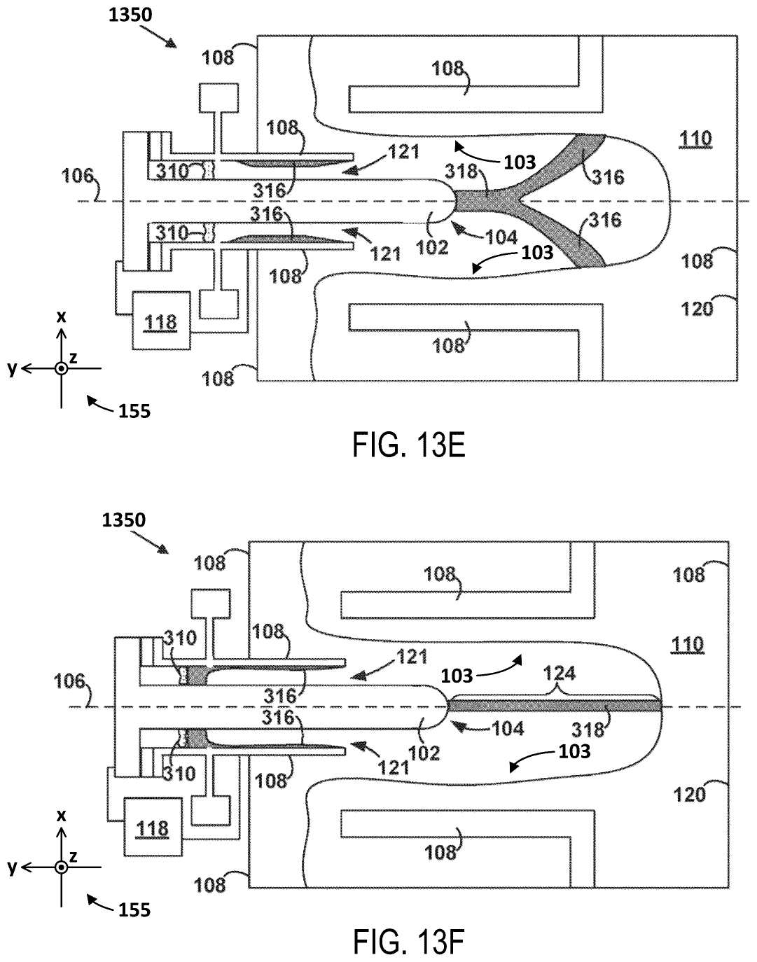

Referring now to FIGS. 12-13F, operational aspects of a plasma confinement system, such as the plasma confinement system 100 described in detail above with reference to FIG. 1, are illustrated. Specifically, in FIG. 12, a block diagram of a method 1200 for operating a plasma confinement system including a flowing metal electrode coating is shown, and, in FIGS. 13A-13F, schematic cross-sectional diagrams of a portion 1350 of the plasma confinement system 100 of FIG. 1 and functionality thereof are shown. Accordingly, FIGS. 1 and 13A-13F, viewed together, illustrate at least some of the aspects of the method 1200 as described below. In an example embodiment, operation of the plasma confinement system (e.g., the plasma confinement system 100) may include cycling a (liquid) ternary eutectic alloy through an assembly region of the plasma confinement system. A composition of the ternary eutectic alloy may be pre-selected, for example, to improve a sheared-flow stabilized (SFS) Z-pinch plasma arc confined within the assembly region, e.g., under relatively high temperature and/or relatively low pressure conditions.

In some embodiments, the method 1200, or a portion thereof, may be implemented as executable instructions stored in a non-transitory memory of a computing device, such as a controller communicably coupled to the plasma confinement system. Moreover, in certain embodiments, additional or alternative sequences of steps may be implemented as executable instructions on such a computing device, where individual steps discussed with reference to the method 1200 may be added, removed, substituted, modified, or interchanged.

At block 1202, the method 1200 may include generating a request to initialize the plasma confinement system, according to which an initialization phase of the plasma confinement system may be initiated. In an example embodiment, the request may be generated responsive to receiving a user input, e.g., from an operator of the plasma confinement system. For instance, initialization of the plasma confinement system may be triggered or otherwise initiated via an operator interacting with a user interface, e.g., a push button switch, toggle switch, or other mechanical actuator, a keyboard, a touchscreen, a cursor input, etc.

At dashed block 1204, the method 1200 may include liquifying or otherwise melting the ternary eutectic alloy. For instance, the ternary eutectic alloy may be heated (e.g., melted) into a liquid state using a heating element disposed within the plasma confinement system. In an example embodiment, the ternary eutectic alloy may include metals which mutually act as a heat transfer medium, a tritium-breeding blanket, and a radiation shield. For example, the ternary eutectic alloy may be a cutectic Pb—Li—Sn alloy preselected to induce and sustain thermonuclear fusion at temperatures as high as 600° C. or higher and/or pressures as low as 10⁻⁹ atm or lower.

It should be noted that the dashing of the dashed block 1204 indicates that a corresponding method step (or a portion of the method step) may be optional in the method 1200 in certain embodiments. For example, in certain embodiments, the ternary eutectic alloy may be in a liquid state when the initialization phase of the plasma confinement system is initiated at the block 1202 (e.g., at room temperature).

At block 1206, the method 1200 may include beginning (e.g., inducing) a flow of the ternary eutectic alloy (e.g., liquified/melted at the block 1204) within a vacuum chamber of the plasma confinement system, such as within a plasma confinement chamber (e.g., a combined volume of the acceleration region and the assembly region) configured within the vacuum chamber. For instance, one or more pumps may cycle, circulate, pump, or otherwise move at least a portion of the ternary eutectic alloy within the plasma confinement chamber, wherein the ternary cutectic alloy may absorb current and/or heat (e.g., generated by fusion reactions during a plasma are generation phase of the plasma confinement system, as described in greater detail below). Additionally or alternatively, a heat exchanger may pump or otherwise receive at least a portion of the ternary eutectic alloy heated within the plasma confinement system, extract heat from the at least the portion of the ternary cutectic alloy, and cycle, circulate, pump, or otherwise move the at least the portion of the ternary eutectic alloy back to the plasma confinement chamber (e.g., via the one or more pumps) to continue to absorb current and/or heat.

At block 1208, the method 1200 may include initiating the plasma arc generation phase of the plasma confinement system, e.g., following the initialization phase. Specifically, in an example embodiment, the plasma arc generation phase may be initiated at least by powering up the plasma confinement system (e.g., one or more power supplies may supply power to various components utilized during the plasma arc generation phase) and providing a fuel gas [e.g., one or more neutral gas species, such as including dihydrogen (e.g., H₂, D₂, and/or T₂), other protium-, deuterium-, and/or tritium-containing species, ³He, ⁶Li, ¹¹B, borane, etc., and/or one or more pre-ionized gas species) for forming a plasma to an acceleration region of the plasma confinement system by increasing one or more valve openings. In some embodiments, to augment the sheared flow profile created by neutral gas injection, injection of pre-ionized gas using plasma injectors, plasma guns, or ion sources may be employed in conjunction. In such embodiments, accordingly, plasma injection may occur rapidly and on the same scale as block 1208, and may be used to control formation/initialization and dynamics of the plasma arc. In certain embodiments, the ternary eutectic alloy may increase a TBR within the plasma confinement chamber when flowed therein, e.g., as compared to an absence of the ternary eutectic alloy from the plasma confinement chamber or as compared to a TBR effected by a binary Pb—Li alloy flowed within the plasma confinement chamber.

For example, and as shown in FIGS. 13A and 13B, the one or more gas ports 116 may direct fuel gas 310 [e.g., including dihydrogen (e.g., H₂, D₂, and/or T₂), ³He, ⁶Li, ¹¹B, borane, etc., and/or one or more pre-ionized gas species] into the acceleration region 121 between the inner electrode 102 and the outer electrode 103 (e.g., the solid conductive shell 108) that substantially surrounds the inner electrode 102. FIG. 13A shows an initial amount of the fuel gas 310 entering the acceleration region 121 and FIG. 13B shows an additional amount of the fuel gas 310 entering the acceleration region 121 thereafter.

After flowing the fuel gas 310, a gas pressure adjacent to the one or more gas ports 116 within the acceleration region 121 may be within a range of 1000 to 5800 Torr (e.g., 5450 to 5550 Torr) prior to the voltage between the inner electrode 102 and the outer electrode 103 (e.g., the solid conductive shell 108) being applied via the power supply 118.

At block 1210, the method 1200 may include generating the plasma arc between the inner electrode and the ternary eutectic alloy (e.g., the outer electrode) in the plasma confinement chamber, e.g., during the plasma arc generation phase. In an example embodiment, the Z-pinch discharge current may be applied at a repetition rate between the inner electrode and the ternary eutectic alloy to generate the plasma arc. During operation of the plasma confinement system, the ternary eutectic alloy may function as either a cathode in some embodiments or an anode in other embodiments. The plasma arc may be confined, compressed, and sustained via an axially symmetric (e.g., azimuthally symmetric, such as about an axis of rotation) magnetic field generated by the Z-pinch discharge current, with the Z-pinch discharge current stabilized by a sheared ion velocity flow created and maintained via an applied residual current.

For example, and as shown in FIGS. 13C-13F, the power supply 118 may apply a voltage between the inner electrode 102 and the outer electrode 103 (e.g., the solid conductive shell 108), thereby converting at least a portion of the fuel gas 310 into a Z-pinch plasma 318 (see FIGS. 13C-13F) that flows between: (i) the eutectic alloy 110 disposed on the solid conductive shell 108 of the outer electrode 103 and on the longitudinal axis 106 of the plasma confinement system 100; and (ii) the rounded first end 104 of the inner electrode 102.

For example, the power supply 118 may apply the voltage between the inner electrode 102 and the solid conductive shell 108, thereby converting at least a portion of the fuel gas 310 into a plasma 316 (see FIGS. 13C-13F) having a substantially annular cross section. Due to the magnetic field generated by its own current, the plasma 316 may flow axially within the acceleration region 121 toward the first end 104 of the inner electrode 102 and the first end 120 of the outer electrode 103 as shown sequentially in FIGS. 13C-13F.

As shown in FIGS. 13E and 13F, when the plasma 316 moves beyond the acceleration region 121, a Z-pinch plasma 318 may be established in the assembly region 124 within the outer electrode 103 between: (i) the cutectic alloy 110 disposed on the solid conductive shell 108 of the outer electrode 103 and on the longitudinal axis 106 of the plasma confinement system 100; and (ii) the rounded first end 104 of the inner electrode 102. In some embodiments, such as when the inner electrode 102 functions as an anode and the outer electrode 103 functions as a cathode, each of an ion current forming the Z-pinch plasma 318 and a sheared axial (ion velocity) flow stabilizing the ion current may flow from the first end 104 of the inner electrode 102 to the outer electrode 103. In other embodiments, such as when the inner electrode 102 functions as the cathode and the outer electrode 103 functions as the anode, the ion current may flow from the outer electrode 103 to the first end 104 of the inner electrode 102 and the sheared axial flow may flow from the first end 104 of the inner electrode 102 to the outer electrode 103. Accordingly, in the preceding embodiments, plasma velocity (e.g., the sheared axial flow) may flow from within the assembly region 124 (e.g., from the first end 104 of the inner electrode 102) to the outer electrode 103 (e.g., towards the first end 120 of the outer electrode 103), while the ion current may flow from the anode to the cathode.

The Z-pinch plasma 318 may exhibit sheared axial flow and/or may have a radius between 0.1 mm and 5 mm, an ion temperature between 900 and 50,000 eV, an electron temperature greater than 500 eV (e.g., up to 50,000 eV), an ion number density greater than 1×10²³ ions/m³, an electron number density greater than 1×10²³ electrons/m³, and/or a magnetic field over 8 T, and/or may be stable for at least 10 μs (e.g., up to 1 ms or more).

At block 1212, the method 1200 may include determining whether to stop the plasma arc generation, e.g., according to a request generated at the plasma confinement system. If no stopping of the plasma arc generation is indicated, the method 1200 may return to block 1210 to continue generating the plasma arc in the plasma confinement chamber.

If stopping plasma arc generation is indicated, the method 1200 may proceed to block 1214, whether the method 1200 may include stopping plasma arc generation. Specifically, the Z-pinch discharge current may cease being applied to the plasma and the one or more valve openings may be decreased or altogether closed to reduce or cease supplying the fuel gas to the plasma confinement chamber, such that the plasma arc may become unsustainable and cease.

At block 1216, the method 1200 may include ceasing the flow of the ternary eutectic alloy within the plasma confinement chamber. For instance, the one or more pumps and/or the heat exchanger may be deactivated such that the ternary eutectic alloy is prevented from flowing. Additionally or alternatively, if the heating element is used to liquefy/melt the ternary eutectic alloy, the heating element may be deactivated such that the ternary eutectic alloy returns to a solid or more viscous state.

Embodiments of the present disclosure can be described in view of the following clauses:
1. A plasma confinement system, comprising:
   a solid conductive shell; and
   a liquid composition coating at least a portion of the solid conductive shell, the liquid composition including a plurality of metals and having a lower vapor pressure, at a temperature level at which the plasma confinement system operates, than another composition formed from at least two of the plurality of metals.
2. The plasma confinement system of clause 1, wherein the liquid composition comprises a ternary eutectic alloy comprising one or more of Sn, Pb, In, Ga, or Tl.
3. The plasma confinement system of clause 2, wherein the ternary eutectic alloy includes Pb, Li, and Sn.
4. The plasma confinement system of clause 3, wherein the ternary eutectic alloy has a composition of PbₓLi_{y}Sn_{z}, where 0.1≤x≤0.3, 0.1≤y≤0.4, and 0.4≤z≤0.71.
5. The plasma confinement system of any one of clauses 1-4, wherein the liquid composition comprises one or more of Na, K, Bi, Hg, Be, a Na-78K alloy, a Bi-43.7Pb eutectic alloy, or FLiBe.
6. The plasma confinement system of any one of clauses 1-5, wherein the liquid composition has a melting point within a range of −40° C. to 450° C. at 1 atm.
7. The plasma confinement system of clause 6, wherein the melting point is within a range of 35° C. to 330° C. at 1 atm.
8. The plasma confinement system of any one of clauses 1-7, wherein the liquid composition remains homogeneous during operation of the plasma confinement system.
9. The plasma confinement system of any one of clauses 1-8, wherein at least one metal of the plurality of metals includes an atomic radius within 15% of another metal of the plurality of metals.
10. The plasma confinement system of any one of clauses 1-9, wherein each metal of the plurality of metals includes crystal lattice affinity.
11. The plasma confinement system of any one of clauses 1-10, wherein each metal of the plurality of metals includes >96% metallic bonding.
12. The plasma confinement system of any one of clauses 1-11, wherein each metal of the plurality of metals includes a melting point within 150° C. of each other metal of the plurality of metals.
13. The plasma confinement system of any one of clauses 1-12, wherein the temperature level is >700° C., and wherein the plasma confinement system operates at a vacuum level of <10⁻⁶ Torr.
14. The plasma confinement system of any one of clauses 1-13, wherein the liquid composition increases a tritium breeding ratio within the plasma confinement system.
15. The plasma confinement system of any one of clauses 1-14, wherein the plasma confinement system is a Z-pinch plasma confinement system.
16. A method, comprising:
   inducing flow of a eutectic alloy, the eutectic alloy including a first metal, a second metal, and a third metal, the first metal reducing a vapor pressure of an alloy formed from the second and third metals.
17. The method of clause 16, wherein the eutectic alloy remains freely flowing at a temperature between 500° C. and 700° C., and wherein the vapor pressure is reduced to between 10⁻¹⁰ atm and 10⁻⁸ atm at the temperature.
18. The method of any one of clauses 16 or 17, wherein the flow of the eutectic alloy is induced within a vacuum chamber of a Z-pinch plasma confinement system.
19. A Z-pinch plasma confinement system, comprising:
   an electrode including an electrode material which freely flows at an operating temperature of the Z-pinch plasma confinement system and has a lower vapor pressure than a binary Pb—Li alloy at the operating temperature.

20. The Z-pinch plasma confinement system of clause 19, wherein the lower vapor pressure is less than 10⁻⁹ atm and the operating temperature is 600° C.

The specification and drawings are to be regarded in an illustrative rather than a restrictive sense. It will, however, be evident that various modifications and changes may be made thereunto without departing from the broader spirit and scope of the invention as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the invention to the specific form or forms disclosed but, on the contrary, the intention is to cover all modifications, alternative constructions, and equivalents falling within the spirit and scope of the invention, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. Similarly, use of the term “or” is to be construed to mean “and/or” unless contradicted explicitly or by context. The terms “comprising,” “having,” “including,” and “containing” are to be construed as open-ended terms (i.e., meaning “including, but not limited to,”) unless otherwise noted. The term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. The use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and the corresponding set may be equal. The use of the phrase “based on,” unless otherwise explicitly stated or clear from context, means “based at least in part on” and is not limited to “based solely on.”

Conjunctive language, such as phrases of the form “at least one of A, B, and C,” or “at least one of A, B and C,” (i.e., the same phrase with or without the Oxford comma) unless specifically stated otherwise or otherwise clearly contradicted by context, is otherwise understood within the context as used in general to present that an item, term, etc., may be either A or B or C, any nonempty subset of the set of A and B and C, or any set not contradicted by context or otherwise excluded that contains at least one A, at least one B, or at least one C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}, and, if not contradicted explicitly or by context, any set having {A}, {B}, and/or {C} as a subset (e.g., sets with multiple “A”). Thus, such conjunctive language is not generally intended to imply that certain embodiments require at least one of A, at least one of B and at least one of C each to be present. Similarly, phrases such as “at least one of A, B, or C” and “at least one of A, B or C” refer to the same as “at least one of A, B, and C” and “at least one of A, B and C” refer to any of the following sets: {A}, {B}, {C}, {A, B}, {A, C}, {B, C}, {A, B, C}, unless differing meaning is explicitly stated or clear from context. In addition, unless otherwise noted or contradicted by context, the term “plurality” indicates a state of being plural (e.g., “a plurality of items” indicates multiple items). The number of items in a plurality is at least two but can be more when so indicated either explicitly or by context.

Operations of processes described herein can be performed in any suitable order unless otherwise indicated herein or otherwise clearly contradicted by context. In an embodiment, a process such as those processes described herein (or variations and/or combinations thereof) is performed under the control of one or more computer systems configured with executable instructions and is implemented as code (e.g., executable instructions, one or more computer programs or one or more applications) executing collectively on one or more processors, by hardware or combinations thereof. In an embodiment, the code is stored on a computer-readable storage medium, for example, in the form of a computer program comprising a plurality of instructions executable by one or more processors. In an embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In an embodiment, code (e.g., executable code or source code) is stored on a set of one or more non-transitory computer-readable storage media having stored thereon executable instructions that, when executed (i.e., as a result of being executed) by one or more processors of a computer system, cause the computer system to perform operations described herein. The set of non-transitory computer-readable storage media, in an embodiment, comprises multiple non-transitory computer-readable storage media, and one or more of individual non-transitory storage media of the multiple non-transitory computer-readable storage media lack all of the code while the multiple non-transitory computer-readable storage media collectively store all of the code. In an embodiment, the executable instructions are executed such that different instructions are executed by different processors—for example, in an embodiment, a non-transitory computer-readable storage medium stores instructions and a main CPU executes some of the instructions while a graphics processor unit executes other instructions. In another embodiment, different components of a computer system have separate processors and different processors execute different subsets of the instructions.

Accordingly, in an embodiment, computer systems are configured to implement one or more services that singly or collectively perform operations of processes described herein, and such computer systems are configured with applicable hardware and/or software that enable the performance of the operations. Further, a computer system, in an embodiment of the present disclosure, is a single device and, in another embodiment, is a distributed computer system comprising multiple devices that operate differently such that the distributed computer system performs the operations described herein and such that a single device does not perform all operations.

The use of any and all examples or exemplary language (e.g., “such as”) provided herein is intended merely to better illuminate embodiments of the invention and does not pose a limitation on the scope of the invention unless otherwise claimed. No language in the specification should be construed as indicating any non-claimed element as essential to the practice of the invention.

Embodiments of this disclosure are described herein, including the best mode known to the inventors for carrying out the invention. Variations of those embodiments may become apparent to those of ordinary skill in the art upon reading the foregoing description. The inventors expect skilled artisans to employ such variations as appropriate, and the inventors intend for embodiments of the present disclosure to be practiced otherwise than as specifically described herein. Accordingly, the scope of the present disclosure includes all modifications and equivalents of the subject matter recited in the claims appended hereto as permitted by applicable law. Moreover, any combination of the above-described elements in all possible variations thereof is encompassed by the scope of the present disclosure unless otherwise indicated herein or otherwise clearly contradicted by context.

All references including publications, patent applications, and patents cited herein are hereby incorporated by reference to the same extent as if each reference were individually and specifically indicated to be incorporated by reference and were set forth in its entirety herein.

1. A plasma confinement system, comprising:
a solid conductive shell; and
a liquid composition coating at least a portion of the solid conductive shell, the liquid composition including a plurality of metals and having a lower vapor pressure, at a temperature level at which the plasma confinement system operates, than another composition formed from at least two of the plurality of metals.

2. The plasma confinement system of claim 1, wherein the liquid composition comprises a ternary eutectic alloy comprising one or more of Sn, Pb, In, Ga, or Tl.

3. The plasma confinement system of claim 2, wherein the ternary eutectic alloy includes Pb, Li, and Sn.

4. The plasma confinement system of claim 3, wherein the ternary eutectic alloy has a composition of PbₓLi_{y}Sn_{z}, where 0.1≤x≤0.3, 0.1≤y≤0.4, and 0.4≤z≤0.7.

5. The plasma confinement system of claim 1, wherein the liquid composition comprises one or more of Na, K, Bi, Hg, Be, a Na-78K alloy, a Bi-43.7Pb eutectic alloy, or FLiBe.

6. The plasma confinement system of claim 1, wherein the liquid composition has a melting point within a range of −40° C. to 450° C. at 1 atm.

7. The plasma confinement system of claim 6, wherein the melting point is within a range of 35° C. to 330° C. at 1 atm.

8. The plasma confinement system of claim 1, wherein the liquid composition remains homogeneous during operation of the plasma confinement system.

9. The plasma confinement system of claim 1, wherein at least one metal of the plurality of metals includes an atomic radius within 15% of another metal of the plurality of metals.

10. The plasma confinement system of claim 1, wherein each metal of the plurality of metals includes crystal lattice affinity.

11. The plasma confinement system of claim 1, wherein each metal of the plurality of metals includes >96% metallic bonding.

12. The plasma confinement system of claim 1, wherein each metal of the plurality of metals includes a melting point within 150° C. of each other metal of the plurality of metals.

13. The plasma confinement system of claim 1, wherein the temperature level is >700° C., and wherein the plasma confinement system operates at a vacuum level of <10⁻⁶ Torr.

14. The plasma confinement system of claim 1, wherein the liquid composition increases a tritium breeding ratio within the plasma confinement system.

15. The plasma confinement system of claim 1, wherein the plasma confinement system is a Z-pinch plasma confinement system.

16. A method, comprising:
inducing flow of a eutectic alloy, the eutectic alloy including a first metal, a second metal, and a third metal, the first metal reducing a vapor pressure of an alloy formed from the second and third metals.

17. The method of claim 16, wherein the eutectic alloy remains freely flowing at a temperature between 500° C. and 700° C., and
wherein the vapor pressure is reduced to between 10⁻¹⁰ atm and 10⁻⁸ atm at the temperature.

18. The method of claim 16, wherein the flow of the eutectic alloy is induced within a vacuum chamber of a Z-pinch plasma confinement system.

19. A Z-pinch plasma confinement system, comprising:
an electrode including an electrode material which freely flows at an operating temperature of the Z-pinch plasma confinement system and has a lower vapor pressure than a binary Pb—Li alloy at the operating temperature.

20. The Z-pinch plasma confinement system of claim 19, wherein the lower vapor pressure is less than 10⁻⁹ atm and the operating temperature is 600° C.
